(19) United States
(12) Patent Application Publication
(10) Pub. No.: US 2019/0147358 A1
(43) Pub. Date: May 16, 2019

(54) SYSTEM AND METHOD FOR TIME-TO-EVENT PROCESS ANALYSIS

(71) Applicants: Gangaram S. Ladde, Temple Terrace, FL (US); Emmanuel A. Appiah, Tampa, FL (US); Jay G. Ladde, Orlando, FL (US)

(72) Inventors: Gangaram S. Ladde, Temple Terrace, FL (US); Emmanuel A. Appiah, Tampa, FL (US); Jay G. Ladde, Orlando, FL (US)

(73) Assignee: University of South Florida, Tampa, FL (US)

(21) Appl. No.: 16/178,048

(22) Filed: Nov. 1, 2018

Related U.S. Application Data
(60) Provisional application No. 62/674,258, filed on May 21, 2018.
(60) Provisional application No. 62/580,151, filed on Nov. 1, 2017.

(51) Int. Cl. G06N 7/00; G06F 17/18; G06F 17/50

(52) U.S. Cl. CPC G06N 7/005; G06F 17/5009; G06F 17/18

(57) ABSTRACT

An innovative nonlinear hybrid dynamic model of survival data analysis implemented in a systematic and unified way that is independent on any particular form of survival distributions functions or data sets. The introduction of one or more intervention processes provides a measure of influence for new tools, procedures and approaches continuous-time states of a time-to-event dynamic process.

### CROSS-REFERENCE TO RELATED APPLICATIONS

This application claims priority to currently pending U.S. Provisional Application No. 62/580,151, filed Nov. 1, 2017 and U.S. Provisional Application No. 62/674,258, filed May 21, 2018, the entire contents of which are hereby incorporated herein by reference.

### GOVERNMENT SUPPORT STATEMENT

This invention was made with Federal Government support under W911NF-15-1-0182 awarded by the US Army Research Office. The Government has certain rights in the invention.

### BACKGROUND OF THE INVENTION

The human mobility, electronic communications, technological changes, advancements in engineering, medical, and social sciences have diversified and extended the role and scope of time-to-event processes in biological, cultural, epidemiological, financial, military and social sciences. It is known that sudden changes in the hazard rate/risk at unspecified or specified times are frequently encountered in engineering, financial, medical, technological and social sciences. These changes could occur multiple times. As a result, investigators are often interested in (a) estimating the sizes and locations of changing trends of the detected changes in the hazard rate/risk and (b) detecting the effects and trends of location of changes in (a).

In the existing literature, probabilistic functions (failure (F), survival (S)) in the study of binary state of time-to-event processes are based on two mutually exclusive Bernoulli-type of outcomes of time varying events (S(t)+F(t)=1, “closed dynamic process”. The existing Maximum likelihood, Bayesian, and Nonparametric methods are “single shot” techniques. Moreover, primarily, the closed-form survival/failure function distributions have played a dominant role in the study of time-to-event data analysis.

In general, solutions of binary choice response problems in the real world are not mutually exclusive. In view of this, we have S (t)+F (t)+E (t)=1, where E represents an uncertainty, ignorance or imperfectness, which may be deterministic or stochastic, error process in an open or closed system.

Accordingly, what is needed in the art is an improved predictable system and method for an interconnected state dynamic model of entities under observation and probabilistic binary state time-to-event processes with intra-subsystems and inter-subsystems interacting or influencing either, simultaneously or mutually exclusively, for both a closed or open dynamic process.

### SUMMARY OF INVENTION

In various embodiments, the present invention provides an innovative, nonlinear and nonstationary hybrid dynamic model of survival data analysis in a systematic and unified way. The procedure for the development of the model is based on the following five subcomponents: (1) Development Innovative Interconnected Nonlinear Hybrid Dynamic Model for Time-to-Event Processes, (2) Construction of an Interconnected Nonlinear Hybrid Dynamic Model for Survival Species and Binary State Time-to-Event Process, (3) Derivation of Discrete-time Interconnected Conceptual/Theoretical State Observation Dynamic Model, (4) Formation of Interconnected Dynamic Model for Time-to-Event Data Statistic, and (5) Development of the Innovative Interconnected Discrete-Time Dynamic Model for Nonlinear Time-to-Event Statistical Data Analysis, in accordance with the present invention.

The present invention provides for an innovative method for modeling time-to-event processes, herein referred to as the interconnected nonlinear hybrid dynamic modeling method, or in short, the dynamic TTE (time-to-event) method. The dynamic TTE method of the present invention is based on sound mathematical foundations, including: (a) the Ito-Doob stochastic calculus, (b) fundamental properties of developed stochastic differential equations (SDE) models such as continuous dependence of solution process with respect initial data and parameters, (c) monotone increasing property of probabilistic binary state time-to-event dynamic model with respect to initial state data, formulation of transformed differential equations (stochastic moment differential equations) for suitable transformations with respect to developed SDE Model.

In one embodiment, the present invention provides a method for estimating a time-to-event, which includes obtaining a time-series data set for a plurality of entities under the influence of one or more intervention processes and estimating a time-to-event based upon a combination of a continuous-time analysis and a discrete-time analysis of the historical data and the one or more intervention processes.

In the system and methods of the present invention estimating a time-to-event is not dependent upon a probability distribution function.

Additionally, in the present invention, the intervention processes may include one or more of, a change in treatment processes, a newly developed technology, a newly developed drugs, newly designed, refined, efficient and effective tools/machines in engineering, usage of modern electronic devices/tools in technological and management sciences, and maximizing diversity, opportunities and benefits for the betterment of the modern civilized global world. The one or more intervention processes may be intra-interventions, inter-interventions, and extra-interventions.

The method of the present invention utilizes a stochastic interconnected nonlinear hybrid dynamic model for survival species and binary state time-to-event process for estimating a time-to-event based upon a combination of a continuous-time analysis and a discrete-time analysis of the historical data and the one or more intervention processes.

In an additional embodiment, the present invention provides a system for estimating a time-to-event, which includes, a computer-implemented interconnected hybrid dynamic time-to-event model comprising continuous-time time-to-event processes and discrete-time time-to-event processes. The computer-implemented model is configured to, obtain a time-series data set for a plurality of entities under the influence of one or more intervention processes and to estimate a time-to-event based upon a combination of a continuous-time analysis and a discrete-time analysis of the historical data and the one or more intervention processes.

In another embodiment, the present invention provides a non-transitory computer-readable medium, the computer-readable medium having computer-readable instructions stored thereon that, when executed by a computing device processor, cause the computing device to, obtain a time-series data set for a plurality of entities under the influence of one or more intervention processes and estimate a time-to-event based upon a combination of a continuous-time analysis and a discrete-time analysis of the historical data and the one or more intervention processes.

Accordingly, in various embodiments, the present invention provides an improved predictable system and method for an interconnected state dynamic model of entities/subjects/objects under observations/study/investigations and probabilistic binary state time-to-event processes with intra-subsystems and inter-subsystems interacting or influencing either, simultaneously or mutually exclusively, as applied to closed or open dynamic processes.

### BRIEF DESCRIPTION OF THE DRAWINGS

For a fuller understanding of the invention, reference should be made to the following detailed description, taken in connection with the accompanying drawings, in which:

FIG. 1 illustrates the various development stages for a System and Method for Nonlinear Time-to-Event Statistical Data Analysis, in accordance with an embodiment of the present invention.

FIG. 2 is a flow diagram illustrating the conceptual computational Interconnected Dynamic Model for Time-to-Event Data Statistic, in accordance with an embodiment of the present invention.

FIG. 3 is a flow diagram illustrating the simulation computational method for the Interconnected Dynamic Model for Time-to-Event Data Statistic, in accordance with an embodiment of the present invention.

FIG. 4 coupled with FIG. 2, forms a flow diagram illustrating the conceptual computational method for the Innovative Interconnected Discrete-time Dynamic Model for Nonlinear Time-to-Event Statistical Data Analysis, in accordance with an embodiment of the present invention.

FIG. 5 coupled with FIG. 3 forms a flow diagram illustrating the simulation computational method for the Innovative Interconnected Discrete-time Dynamic Model for Nonlinear Time-to-Event Statistical Data Analysis, in accordance with an embodiment of the present invention.

FIG. 6 provides a graphical illustration of the real, simulated, forecast and 95% confidence interval for the data set comprising Length of Remission in Weeks for Control Group of Leukemia Patients, in accordance with an embodiment of the present invention.

FIG. 7 provides a graphical illustration of the real, simulated, forecast and 95% confidence interval for the data set comprising Numbers of Million Revolutions Failure Times for Each of 23 Bearings, in accordance with an embodiment of the present invention.

FIG. 8 provides a graphical illustration of the real, simulated, forecast and 95% confidence interval for the data set comprising Length of Remission in Weeks for Treated Group of Leukemia Patients, in accordance with an embodiment of the present invention.

FIG. 9 provides a graphical illustration of the real, simulated, forecast and 95% confidence interval for the data set comprising The Time-to-Event Data Set in Years of Psychiatric Patients, in accordance with an embodiment of the present invention.

FIG. 10 provides a graphical illustration of the real, simulated, forecast and 95% confidence interval for the data set comprising The Remission Time-to-Event in Weeks for Acute Myelogenous Leukaemia (AML) Data Set, in accordance with an embodiment of the present invention.

FIG. 11 is a tabular illustration of the comparison between the method of the present invention, the Maximum Likelihood and the Kaplan-Meier Method for the data set related to the Length of Remission in Weeks for Control Group of Leukemia Patients.

FIG. 12 is a tabular illustration of the comparison between the method of the present invention, the Maximum Likelihood and the Kaplan-Meier Method for the data set related to the Numbers of Million Revolutions Failure Times for Each of 23 Bearings.

FIG. 13 is a tabular illustration of the comparison between the method of the present invention, the Maximum Likelihood and the Kaplan-Meier Method for the data set related to the Length of Remission in Weeks for Treated Group of Leukemia Patients.

FIG. 14 is a tabular illustration of the comparison between the method of the present invention, the Maximum Likelihood and the Kaplan-Meier Method for the Time-to-Event data set in Years of Psychiatric Patients.

FIG. 15 is a tabular illustration of the comparison between the method of the present invention, the Maximum Likelihood and the Kaplan-Meier Method for the data set related to the Remission in Weeks for Acute Myelogenous Leukaemia (AML) Patients.

The figures illustrate only example embodiments therefore are not to be considered as limiting the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION OF THE INVENTION

In various embodiment, the system and method of the present invention provides state and parameter estimations, thereby addressing two major goals: (1) model validation, and (2) state predictions of continuous-time nonlinear and non-stationary closed/open dynamic models under the influence of time-to-event processes in biological, chemical, engineering, financial, medical, military, physical and social sciences. In addition, the state and parameter estimations provided by the present invention have further application in forecasting, monitoring and planning a predictive state of a given time-to-event data analysis under the influence of internal and external intervention processes, under environmental stochastic perturbations.

The existing literature is centered on the probabilistic analysis in the study of binary state time-to-event processes, which is based on two mutually exclusive events (S (t)+F (t)=1, which is a closed dynamic process. This implies that the binary state of time-to-event process are mutually exclusive. Moreover, it implies that the distributions of two mutually exclusive binary states of the time-to-event dynamic processes satisfy the relation: “(Survival State Probability)+(Failure State Probability)=1” is equivalent to (⇔) the “(Kinetic Energy)+(Potential Energy)=Constant”. Furthermore, in the existing literature it is assumed that the rate of change of survival state probability is equal and the opposite in sign to the rate of change of failure state probability. This is equivalent to Newton's third law of motion wherein, “For every action there is an equal and opposite reaction”, or the laws of conservation of mass and energy, that is, “mass/energy is neither created nor destroyed”. The change of one form of state to the other form of state-exhibiting the “absolute truth”, i.e. the “law of the nature” (abstract). This theoretical viewpoint represents the standard current theory of dynamic modeling of biological, chemical, physical and social sciences, commonly referred to as “closed dynamic systems”. In reality, one is not limited to being influenced by “closed dynamic processes”. In fact, the innovative dynamic TTE method of the present invention allows intra-perturbations, inter-perturbations and extra-perturbations, thereby allowing an open process.

It is known that the probability distribution of continuous random variable approach, as utilized in common probabilistic tools, deals with the probabilistic binary state of time-to-event closed dynamic processes. However, a binary choice of a desired entity of an individual, group, community, etc. may or may not be mutually exclusive. For example, one choice out of two drugs, treatments or services in medical sciences, one choice out of two actions in military sciences, one choice out of two political candidates in local Government system, one choice out of two technological tools or products in engineering sciences, one choice out of two universities or colleges in education, one choice out of two social groups in social sciences, and so on. In fact, in the 21^{st} century, problem solving process often involve one choice out of multiple choices. Almost every multiple-choice response problem in the real world problems, such as in medical sciences, military sciences, local Government system, engineering sciences, higher education, social sciences, and so on, is ultimately reduced to a binary choice response problem. In general, solutions of binary choice response problems are not mutually exclusive. In view of this, the present invention provides a binary state time-to-event open dynamic processes S(t)+F(t)+E(t)=1, where E represents an uncertainty, ignorance or imperfectness error process. Accordingly, the dynamic TTE method of the present invention does not describe the “law of the nature (abstract)”, but rather the developed approach is based upon a generalized version of Newtonian dynamic modeling of probabilistic binary state of time-to-event dynamic process.

Based upon the above discussion, a few fundamental differences can be drawn between the existing probabilistic distribution based methods known in the art and the innovative dynamic TTE method of the present invention. The generalized Newtonian type dynamic modeling needs certain underlying dynamic features, referred to as “cause and effect”. The “cause and effects” depend on a type of population under observation and a probabilistic binary state of time-to-event dynamic process. The probabilistic distribution based methods known in the art are considered to be closed methods. In contrast, the nonlinear dynamic TTE method of the present invention is considered to be inclusive of both closed and open methods. The probabilistic distribution based methods on the prior art are equivalent to the “law of the nature”, whereas the nonlinear dynamic method of the present invention is not equivalent to the law of the nature but is instead an approximation of the reality of the process, which includes imperfections. The prior art probabilistic distribution based method is distribution selection method (trial/error) for a statistical data analysis. The generalized Newtonian type dynamic modeling is a binary choice method (either developing interconnected dynamic model or existing model selection). In fact, a generalized Newtonian type interconnected dynamic model is developed for a population of interest under observation interacting with a binary state time-to-event dynamic process in the context of its either given/known (or feasible to obtain) time-to-event statistical data. The probabilistic distribution based method is a “single shot”, whereas the method of the present invention is “discrete-time dynamic”. The probabilistic distribution based method is limited to interdisciplinary applications, including mathematical knowledge based method, wherein the non-linear dynamic method of the present invention applies to certain interdisciplinary and in depth mathematical knowledge (stochastic analysis, process differential equations, numerical analysis, and so on) based. The non-linear dynamic TTE model of the present invention is based on underlying processes and interactions with internal and external environmental perturbations. The formulation and the development of the innovative nonlinear dynamic model for probabilistic modeling of “survival state” of time-to-event process plays a significant role in real world problems.

In various embodiments, the system and method for dynamic nonlinear time-to-event statistical data analysis in accordance with the present invention, incorporates Kaplan-Meier and Nelson-Aalen type non-parametric methods, systematically. The intervention process of the present invention addresses the issues generated due to sudden changes in the hazard rate at unknown times. The sudden changes may be a result of one or more of: a change in treatment processes, the newly developed technologies and drugs in medical sciences, newly designed, refined, efficient and effective tools/machines in engineering, usage of modern electronic devices/tools in technological and management sciences, and maximizing diversity, opportunities and benefits for the betterment of the modern civilized global world. In addition, the intervention process also alleviates existing issues, including incomplete data, ties, total time test requirement (TTT), piecewise exponential estimator (PEXE), and new PEXE approach in a systematic and coherent manner.

As previously discussed, the dynamic TTE method of the present invention does not require a closed-form survival function distribution. Mathematically speaking, this is a very restrictive assumption. It is known that every random time has cumulative distribution function F, but F may not be continuously differentiable. Even if it is continuously differential it may not belong to the exponential family of distributions. These types of mathematical problems do not arise in the context of the presented innovative dynamic TTE method of the present invention because the inventive method is independent of any probability distribution function. In fact, there is no distribution requirement as long as solution processes satisfy certain boundedness requirements that are less restrictive than the closed form distribution representation that is currently used in the art. As such, the dynamic TTE method of the present invention is independent of existing Maximum Likelihood, Bayesian and non-parametric approaches, which are based on certain features of distribution functions. Moreover, large-scale non-linear and non-stationary interconnected dynamic systems coupled with time-to-event dynamic processes do not possess closed-form survival distribution functions, in general.

The dynamic feature of the system and method of the present invention facilitates the adaptation of current changes and updates statistic processes, such as computer readable instructions. In addition, for j∈I(1, k), at each consecutive failure or change point times tⱼ₋₁^{f/cp}, tⱼ^{f/cp}, the magnitudes of the hazard rate functions \hat{λ}(tⱼ₋₂^{f/cp}, Sⱼ₋₂), \hat{σ}² (tⱼ₋₂^{f/cp}, Sⱼ₋₂) at tⱼ₋₁^{f/cp} and \hat{λ}(tⱼ₋₁^{f}, Sⱼ₋₁) \hat{σ}²(tⱼ₋₁^{f}, Sⱼ₋₁) at tⱼ^{f/cp}, respectively signifies the “size” and “turns” at tⱼ^{f/cp}. Moreover,

$$\vert {\int }_{{t}_{j - ɛ}^{-}}^{{t}_{j}^{-}} dS ( u ) - {\int }_{{t}_{j}^{+}}^{{t}_{j + ɛ}^{+}} dS ( u ) \vert = P ( STT {att}_{j}^{f \text{/} cp} )$$

is the probability measure of size detection and trends at tⱼ^{f/cp}. Furthermore, P(STT attⱼ^{f/cp}) is the measure of effects at the location t_{f}^{f/cp} of change.

The hybrid based system and method of the present invention provides the basis for the measure of influence of constantly emerging, medical, technological, scientific products, tools and procedures. This indeed strengthens the role and scope of the intervention processes under certain predetermined degree of confidence level. For example, we recognize the rapid growth in communication, science and technology, in the 21st century. The different types of consumers (local/global level) are able to interact with each other easily and more frequently. We further recognize the ideas and the historical assumptions regarding the various forms of “network externality functions”. We observe that the group dynamic interactions are going to play a significant role in network goods in the 21st century. The idea of a group dynamic process coupled with the network externality concept leads to a notion of network externality process. By introducing a few terms: consumer/user network, network goods and network externality process, we consider a consumer/user network as a group of interacting consumers/users of similar goods/services/information/knowledge. As such, comparable good/service/thought under the discussion of consumer network is referred to as a network good. A consumer group interacting process of network goods is called a network externality process. Network externality processes influence the values of network goods/services/thoughts. The value of network goods is influenced by both consumer demand-supply functions as well as the network externality process. The influence of network externality process of the network goods/services/thoughts is measured by the consumer/user network size/share. The value of a network good/service/thought influenced by a network externality process is called network externality value. It is determined by the current market size/share. As an illustration, we consider a network good as: as drug/treatment/services, a consumer network is a group of patients for their comparable medical problems; the network externality process is the consumer group interactions such as: sharing their experience, knowledge, and opinions about the drug/treatment/services/tools/etc. The network externality value is the value (price/effectiveness/performance/results) of a drug generated by this group's interaction process. Very recently, this has led to the development of dynamic model of network externality process, established fundamental properties and demonstrated the significance. For the sake of simplicity, we consider,

$$dg = \frac{k}{b - a} ( \frac{g - a}{n - c} ) ( \frac{b - g}{d - n} ) dn , for n ∈ ( c , d ) , \\ g ( n \text{:} {n}_{0} , {S}_{0} ) = b - \frac{b - a}{1 + ( \frac{{g}_{0} - a}{b - {g}_{0}} ) {( \frac{d - {n}_{0}}{{n}_{0} - c} )}^{( \frac{k}{d - c} )} {( \frac{n - c}{d - n} )}^{( \frac{k}{d - c} )}} ,$$

Where n is the market share of drug/treatment/services charge, a<b a, and b are lower and upper limits/threshold values of the affinity/taste of valuable features of network externality process, 0<c<d<1 and g is the cumulative probability distribution externality function. Hence, if k>0, then

$$\frac{dg}{dn} > 0$$

(g also represents probability of the diminishing needs of alternative drugs/treatments/services/tools). In this case, [symbol] is referred to as a positive marginal network externality function. The network externality value increases as the market share increases, that is, [symbol] is an increasing function on (c, d). In this case, g is a probability measure of drug/treatment/service/tool/etc. indicating its demand (There is room for the growth). On the other hand, if k<0, then

$$\frac{dg}{dn} < 0.$$

(g represents the probability measure for existing drug/treatment/service/tool is decreasing (like survival state probability). In this case, [symbol] is referred to as a negative marginal network externality function. Thus, the network externality function decreases as the market share increases, that is, [symbol] is a decreasing function on (c, d). In this case, g is a probability measure of drug/treatment/service/tool with diminishing demand. This information regarding drug/treatment/service/toot provides the performance measure for all of the three parties, namely, consumers/users, providers, and producers. Thus, the developed method can be used to compare the performance of one drug/treatment/service with another. In fact, this provides a method for identifying the most effective drug/service/tool, at least at a local group level. This certainly useful informative tool to make a choice of electing a community leader/representative at a State and the Federal Level. It also sheds a light regarding the survivability/reliability measures to the users.

The benefits of the system and method of the present invention are easily extendable to time-to-event dynamic processes in technological, medical, military, engineering, financial, physical and social sciences, in general, interdisciplinary sciences. Moreover, if data is available certain features can be easily implemented for employing and analyzing certain features that are not currently feasible with existing tools. As a side note, the developed innovative method of the present invention initiates a new area in mathematical sciences: “Survival State Population Dynamic Models” in all disciplines. This approach leads to investigate qualitative properties: sustainability versus unsustainability, reliability versus unreliability, etc. issues in the study of “Survival State Population Dynamic Processes”. This study also provides further insight regarding the time-to-event dynamic process. It further provides insights for understanding survival state invariant sets: sustainable/unsustainable, survival/failure, reliable/unreliable that generate a sense of hope and comfort/satisfaction depending on a type of time-to-event dynamic process. We present very simple and elementary example that would highlight the scope of this work: The role and scope of device implemented method of the present invention would of make a significant contribution in the area of planning and decision making processes. In the following, we present an example that would shed a light on the scope of this theoretical byproduct.

### Example

We consider the following very simple dynamic model for the binary state to-event dynamic process. We consider:

$$\{ \begin{matrix}dS = ( - {β}_{s} S + {α}_{s} ) dt , & S ( {t}_{0} ) = {S}_{0} , & 0 < {S}_{0} < 1 \\ d F = ( - {β}_{F} F + {α}_{F} ) dt , & F ( {t}_{0} ) = {F}_{0} , & 0 < {F}_{0} < {1}^{′}\end{matrix}$$

where β_{S}, α_{S}, β_{F} and α_{F} are positive real numbers; these positive parameters satisfy the following conditions:

$$0 < {α}_{S} < {β}_{S} and {α}_{F} < {β}_{F} . \\ S ( t ) = exp [ - {β}_{s} ( t - {t}_{0} ) ] {S}_{0} + \frac{{α}_{s}}{{β}_{s}} ( 1 - exp [ - {β}_{s} ( t - {t}_{0} ) ] ) and$$

$$F ( t ) = exp [ - {β}_{F} ( t - {t}_{0} ) ] {F}_{0} + \frac{{α}_{F}}{{β}_{F}} ( 1 - exp [ - {β}_{F} ( t - {t}_{0} ) ] )$$

are solution processes. Moreover, 0<F(t)≤1 and 0<S(t)≤1. In addition, F(t)+S(t)=1 provided β≡β_{S}=β_{F} and α_{S}+α_{F}=β. On the basis of the invariant state analysis, we conclude that the

$$\{ ( \frac{{α}_{s}}{β} , \frac{{α}_{F}}{β} ) \}$$

a state invariant set. Moreover, it is asymptotically state invariant set with state size 1.

The presented approach is motivated to develop an interconnected analytic network-centric stochastic hybrid dynamic technique for four interacting nonlinear and nonstationary stochastic dynamic processes described by large-scale systems of complex stochastic dynamic equations. The presented work is not limited to a particular entities/objects/subjects in time-to-event dynamic processes under the influence of discrete-time intervention processes in biological, chemical, cultural, engineering, medical, military, economic, financial, social and technological sciences. Moreover, the current study of time-to-event dynamic processes is treated as an open dynamic processes. This allows us to expand the role, scope and usage of time-to-event dynamic processes beyond the processes in engineering and medical sciences. In the light of this, the population under consideration of study is grouped into two categories, namely, (1) sub-population under study/observation/supervision, and (2) the remaining susceptible sub-population not currently considered under study/observations. The study allows the members of these two sub-population groups to move from one group into the other. The developed algorithm/procedure is independent of any particular form of survival distribution functions or data sets. The dynamic model is developed/generalized (if there is already dynamic model) for the time-to-event dynamic process for which data is already available or easily obtainable. The introduction of intervention processes provides a measure of influence of new tools/procedures/approaches in continuous-time states of time-to-event dynamic process. In addition, intervention processes provide comparison between the past and currently used tools/procedures/approaches/etc.

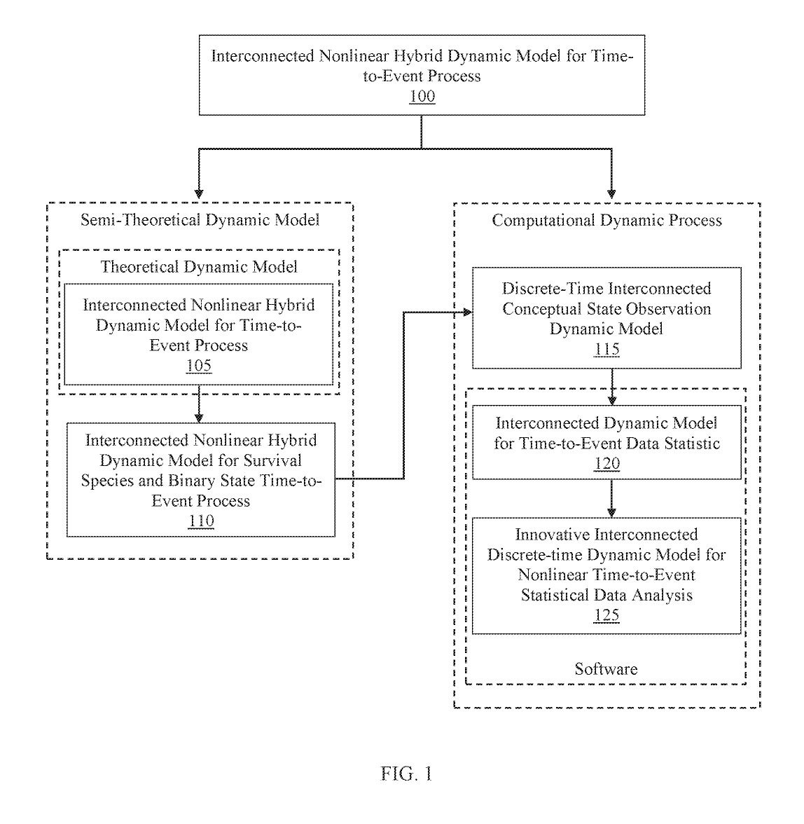

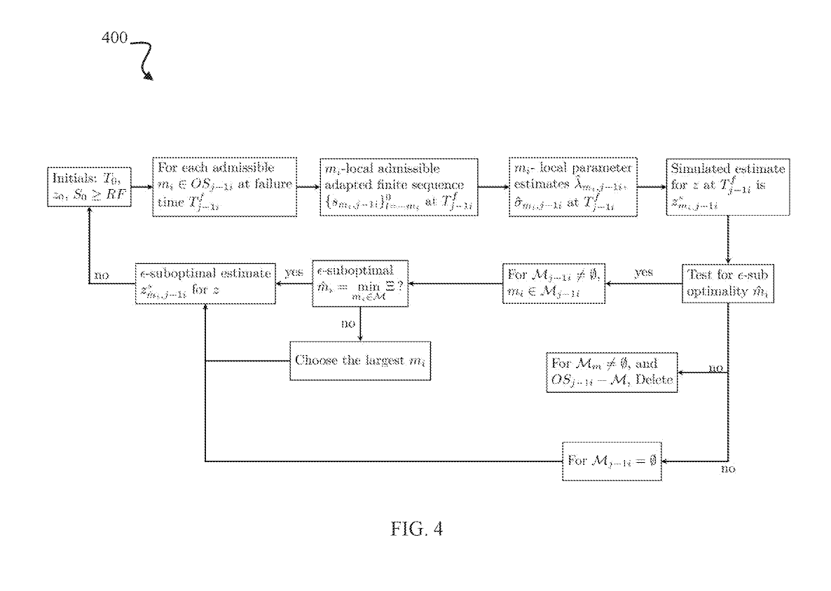

With reference to FIG. 1, it is noted that the development of the system and method of the present invention is within the framework of several proposed multi-scientific objectives, namely, analytical, numerical, statistical, simulation and technological transfer feasibility. Because of this, the developed System and Method for Nonlinear Time-to-Event Statistical Data Analysis 100 of the present invention undergoes at least three transformations as: Interconnected Nonlinear Hybrid Dynamic Model for Time-to-Event Process 105, Interconnected Nonlinear Hybrid Dynamic Model for Survival Species and Binary State Time-to-Event Process 110, and Discrete Time Interconnected Conceptual/Theoretical State Observation Dynamic Model 115. The model transforming processes preserve basic characteristics and features of underlying structural and state dynamic processes. The Discrete Time Interconnected Conceptual/Theoretical State Observation Dynamic Model 115 plays a role in developing the Interconnected Dynamic Model for Time-to-Event Data Statistic 120, and it is the technological component of Innovative Interconnected Nonlinear Hybrid Dynamic Model for Time-to-Event Process 125. The Interconnected Dynamic Model for Time-to-Event Data Statistic 120 couples with the modified version of Local Lagged Adapted Generalized Method of Moments approach (not shown in FIG. 1, see FIG. 4), and generates, Innovative Interconnected Discrete-time Dynamic Model for Nonlinear Time-to-Event Statistical Data Analysis 125.

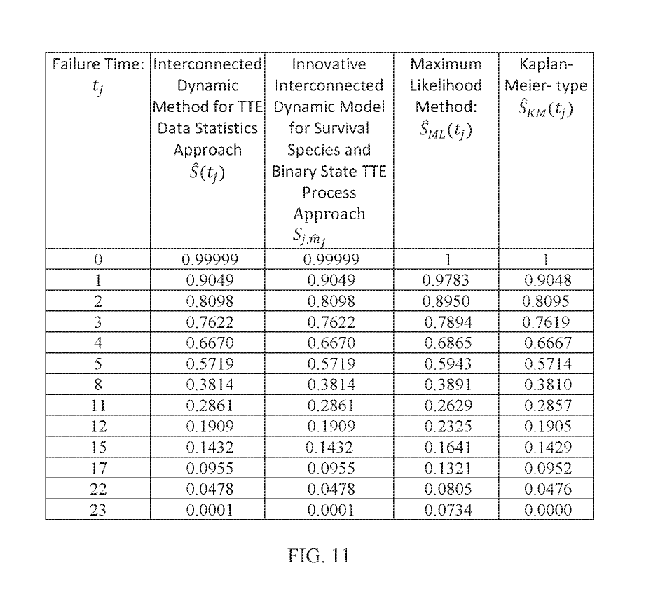

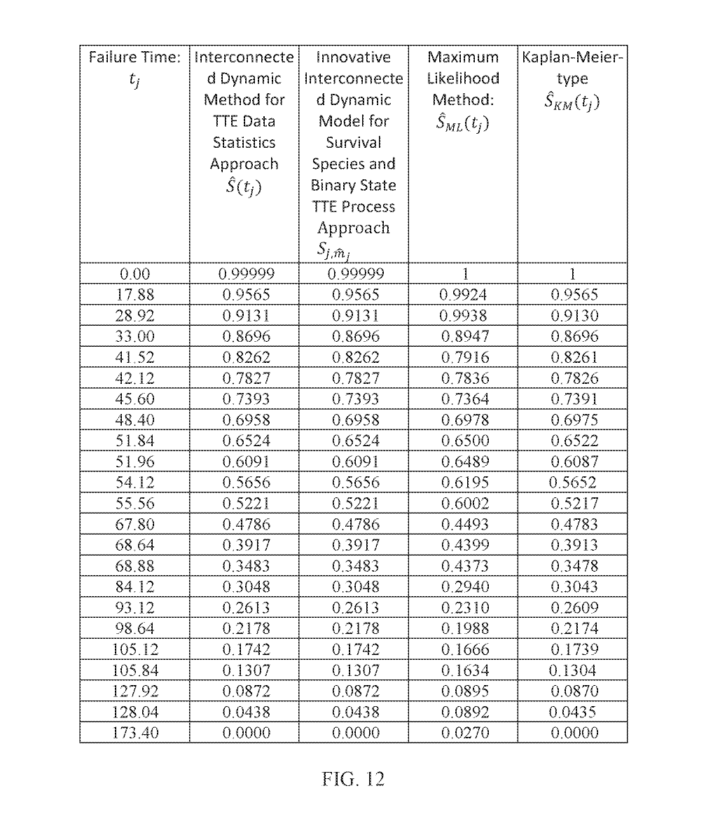

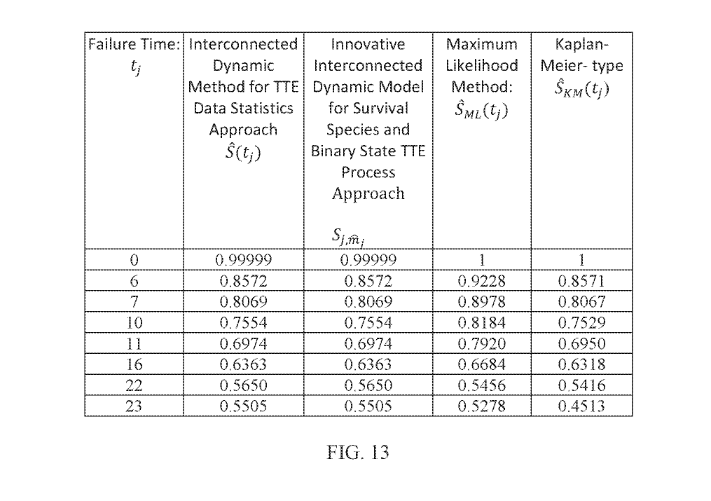

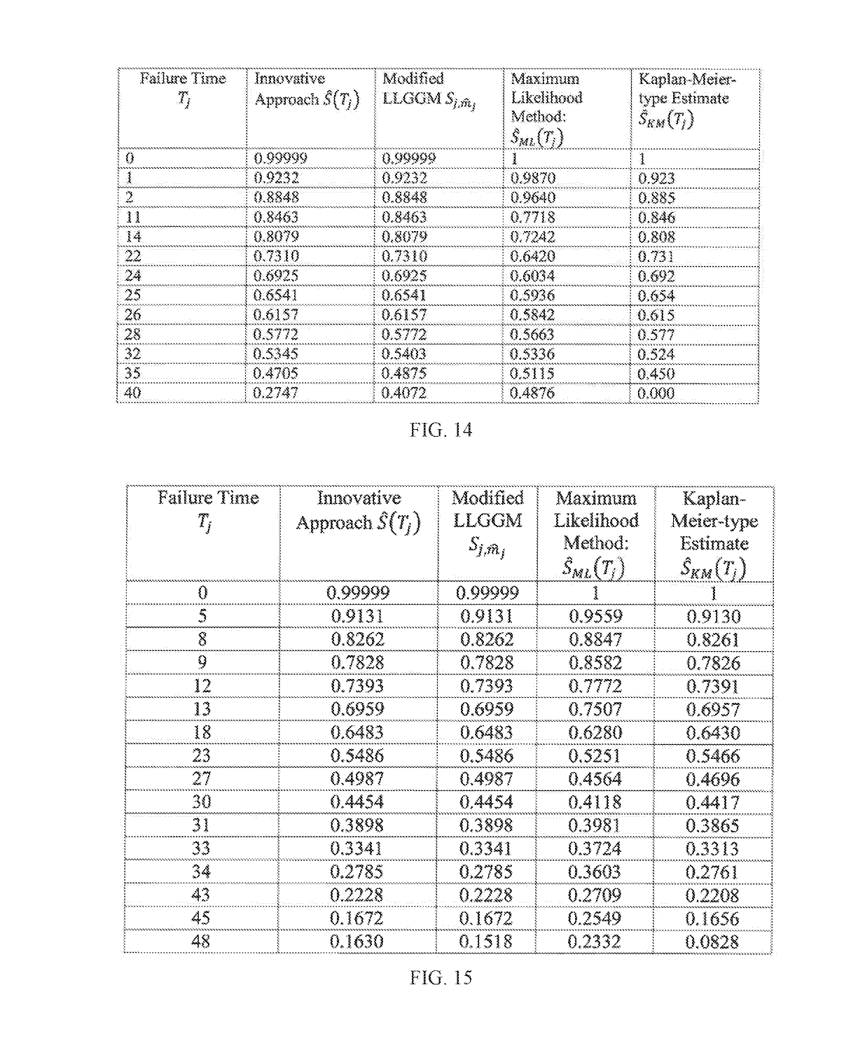

In short, Innovative Interconnected Discrete-time Dynamic Model for Nonlinear Time-to-Event Statistical Data Analysis 125 is a coupled version of Interconnected Dynamic Model for Time-to-Event Data Statistic 120 and Local Lagged Adapted Generalized Method of Moments approach and the overall technological component of Interconnected Nonlinear Hybrid Dynamic Model for Time-to-Event Process 105. The System and Method for Nonlinear Time-to-Event Statistical Data Analysis 100 is built in with the functioning/operating characteristics for technological components Interconnected Dynamic Model for Time-to-Event Data Statistic 120 and Innovative Interconnected Discrete-time Dynamic Model for Nonlinear Time-to-Event Statistical Data Analysis 125 of Interconnected Nonlinear Hybrid Dynamic Model for Time-to-Event Process 105. The usefulness and the significance of both the Interconnected Dynamic Model for Time-to-Event Data Statistic 120 and the Innovative Interconnected Discrete-time Dynamic Model for Nonlinear Time-to-Event Statistical Data Analysis 125 are later exhibited in the context of five time-to-event data sets. The performance comparison of the Innovative Interconnected Discrete-time Dynamic Model for Nonlinear Time-to-Event Statistical Data Analysis 125 with other existing methods, including the Interconnected Dynamic Model for Time-to-Event Data Statistic 120 are provided in FIG. 11, FIG. 12, FIG. 13, FIG. 14, and FIG. 15.

Moreover, the Innovative Interconnected Discrete-time Dynamic Model for Nonlinear Time-to-Event Statistical Data Analysis 125 provides a measure of degree of confidence, prediction, and planning assessments. In short, the Innovative Interconnected Discrete-time Dynamic Model for Nonlinear Time-to-Event Statistical Data Analysis method 125 of the present invention provides a measure of the effectiveness of change-point and/or other effects of intervention processes and it is an open conceptual computational dynamic implementation.

In various exemplary embodiments of the invention, existing real-world time-to-event data sets are utilized to validate the developed interconnected nonlinear hybrid dynamic model of time-to-event process 105 under the assumption that real-world data set was given/drawn/obtained from the population and binary state time-to-event process and to analyze the merit/demerits of usage of discrete-time intervention dynamic processes. Moreover, the real-world time-to-event data sets are drawn/recorded at discrete-time on random time intervals. The random time intervals are associated with a binary-state of time-to-event stochastic dynamic process. Theoretically, there are two goals for parameter and state estimation problems, namely, model (1) validation rather than model misspecification and (2) model prediction. For either continuous/discrete time model validation and prediction goals, we are expected to utilize a given: (A) continuous and/or discrete time dynamic process, and (B) its (continuous/discrete-time state dynamic process in A) real-world data set or vice versa. It is known that the real-world data set in time-to-event process is time-series data and it is drawn, observed, collected or recorded in its discrete-time on a time interval of length finite. The System and Method for Nonlinear Time-to-Event Statistical Data Analysis 100 is built in with five basic components, namely:

### Component-1. Developing Innovative Interconnected Nonlinear Hybrid Dynamic Model for Time-to-Event Processes 105:

In the 21^{st} century, rapid advancements in engineering, medical, and social sciences, electronic communications, and technological changes provide a basis for expansion and extension of role and scope of survival analysis. In fact, everyday daily life is under the influence of both continuous and discrete time (daily routines and interventions) dynamic processes. This has led to the development of an Innovative Interconnected Nonlinear Hybrid Dynamic Model for Time-to-Event Process 105 in a systematic and unified way. It is assumed that a population under an influence of probabilistic binary state time-to-event process is composed into two sub-populations: (1) sub-population under study/observation/supervision, and (2) the remaining susceptible sub-population not currently considered under study/observations. In addition, (A) continuous and/or discrete time dynamic process and (B) its (continuous/discrete-time state dynamic process in A) real-world data set are also known. The study allows the members of these two sub-populations to move from one sub-population into the other. Two of the four interacting nonlinear and nonstationary stochastic dynamic processes are associated with size of entities/objects/subjects under supervised sub-population, and the remaining two processes are with respect to binary state time-to-event dynamic process. The entities/objects/subjects are under the influence of binary state time-to-event dynamic process. The entities/objects/subjects and binary state time-to-event dynamic processes are operating under two time-scales (discrete and continuous times). The development of a model depends on underlying entities/subjects/objects and probabilistic binary state time-to-event process. We note that a developed Innovative Interconnected Nonlinear Hybrid Dynamic Model for Time-to-Event Process 105 is an approximation that is based on underlying dynamic forces, knowledge of forces (if any), experience, the interests and background of the model builder(s). It is well-known that models do not describe the “law of the nature”. In fact, open dynamic processes are subject to various type of errors. We note that the model development is one out of at least two (model selection) options. Here, we chose the model development option. We further noted that the development of the innovative technique is in the framework of the proposed multi-scientific objectives, namely, analytical, numerical, statistical simulation and technological transfer feasibility. Because of this, the developed, we note that a developed Innovative Interconnected Nonlinear Hybrid Dynamic Model for Time-to-Event Process 105 underwent at least following three transformations that preserve basic characteristics and features underlying structural and state dynamic processes including data the known/given discrete time data set as: Interconnected Nonlinear Hybrid Dynamic Model for Survival Species and Binary State Time-to-Event Process 110, and Discrete Time Interconnected Conceptual/Theoretical State Observation Dynamic Model 115, and Interconnected Dynamic Model for Time-to-Event Data Statistic 120, prior to arriving at an Innovative Interconnected Discrete-Time Dynamic Model for Nonlinear Time-to-Event Statistical Data Analysis 125. The three transformed systems are outlined below.

In the light of above discussion and the choice of model development, it is essential to theoretically validate Innovative Interconnected Nonlinear Hybrid Dynamic Model for Time-to-Event Process 105 model existence, uniqueness of solution process as well its fundamental properties such as continuous dependence of solutions with respect on initial conditions and system parameters coupled with non-negativity of solution process. Currently, the most of the available time-to-event data sets are composed of failure and censored subgroups under the observation population.

In view of this, prior to making any assessments, it is natural to validate the developed model in the context of time-to-event data set that was drawn or obtained from at most four interacting processes. Currently, the most of the available time-to-event data sets are composed of failure and censored subgroups under the observation population.

### Component-2: Interconnected Nonlinear Hybrid Dynamic Model for Survival Species and Binary State Time-to-Event Process 110:

Employing on transformation, z=xS, Innovative Interconnected Nonlinear Hybrid Dynamic Model for Time-to-Event Process 105 is transformed into model an Interconnected Nonlinear Hybrid Dynamic Model for Survival Species and Binary State Time-to-Event Process 110 with respect to either chosen or developed dynamic model. The Interconnected Nonlinear Hybrid Dynamic Model for Survival Species and Binary State Time-to-Event Process 110 model provides a basis for a conceptual/theoretical Discrete Time Interconnected Conceptual/Theoretical State Observation Dynamic Model 115. Furthermore, a numerical approximation scheme is used to construct interconnected survival species and binary state time-to-event theoretical time series models. The Discrete-Time Interconnected Conceptual/Theoretical State Observation Dynamic Model 115 was based on one of the goals to develop a System and Method for Nonlinear Time-to-Event Statistical Data Analysis 100 for state and parameter estimations Interconnected Nonlinear Hybrid Dynamic Model for Time-to-Event Process 105. As a footnote, the transformed model Interconnected Nonlinear Hybrid Dynamic Model for Survival Species and Binary State Time-to-Event Process 110 also generates a new avenue for theoretical qualitative analysis of survival species that provides an insight for understanding the impacts and influence of binary state of time-to-event dynamic process on the survival species. The qualitative analysis includes an analysis of survival state invariant sets. In addition, using suitable nonlinear transformation, stochastic moment differential equation are developed in the context of Interconnected Nonlinear Hybrid Dynamic Model for Survival Species and Binary State Time-to-Event Process 110.

### Component-3: Discrete-Time Interconnected Conceptual/Theoretical State Observation Dynamic Model 115:

First, we remark that the derivation of transformed theoretical discrete-time process generates a Discrete-Time Interconnected Conceptual/Theoretical State Observation Dynamic Model 115. We recognize that the Interconnected Nonlinear Hybrid Dynamic Model for Survival Species and Binary State Time-to-Event Process 110 is operating under two different time scales. In view of this, they are operationally isolated. In order to be operationally compatible, comparable, intractable, readable and workable, a discrete-time Euler-type numerical approximation scheme is employed to convert/transform the Interconnected Nonlinear Hybrid Dynamic Model for Survival Species and Binary State Time-to-Event Process 110 and its stochastic moment differential equations into a single-scale “time series models (discrete time)”. We note that Euler-type discretized nonlinear and nonstationary stochastic system of difference equations preserves all continuous-time system parameters, structure and characteristics. Moreover, system of difference (time series) equations depends on lengths of two consecutive point subintervals of the partition of continuous-time domain of operation of Interconnected Nonlinear Hybrid Dynamic Model for Time-to-Event Process 105/Interconnected Nonlinear Hybrid Dynamic Model for Survival Species and Binary State Time-to-Event Process 110. The partition of continuous-time operation of Interconnected Nonlinear Hybrid Dynamic Model for Survival Species and Binary State Time-to-Event Process 110 is synchronized with the time-to-event data collection time schedule/worksheet over the common time domain of study and the continuous time domain of operation of interconnected hybrid dynamic system [t₀, T).

### Component-4.

Interconnected Dynamic Model for Time-to-Event Data Statistic 120: We recall that the Interconnected Nonlinear Hybrid Dynamic Model for Survival Species and Binary State Time-to-Event Process 110 is a semi-technological byproduct of the Innovative Interconnected Nonlinear Hybrid Dynamic Model for Time-to-Event Process 105. The Interconnected Dynamic Model for Time-to-Event Data Statistic 120 and the Innovative Interconnected Discrete-time Dynamic Model for Nonlinear Time-to-Event Statistical Data Analysis 125 are fundamental and overall technological components of Interconnected Nonlinear Hybrid Dynamic Model for Time-to-Event Process 105, respectively. For the performance and operation of the developed technological software, we systematically outline the following step-by-step conceptual computational procedure for parameter and state estimation problems. The parameter estimation steps are as follows: Step-1. Coordination of Discrete-time Processes, Step-2. Real Data Coordination with Data Collection/observation Times, Step-3. Data Decomposition, Reorganization and Aggregation Processes-Overall-time Operating Domain, Step-4. Discrete-time Operating Structural Dynamic of Time-to-Event Process-Overall State Dynamic, Step-5. Data Decomposition, Reorganization and Aggregation Processes-Consecutive-Failure-time Operating Subdomain, Step-6. Conceptual Parameter Estimation Process, Step-7. Conceptual State Estimation Scheme. These steps are briefly presented below.

### Step-1. Coordination of Discrete-Time Process:

For achieving a single goal, all multiple discrete-time dynamic processes are synchronized with a single discrete-time dynamic process. This is achieved based on the natural order in which the discrete-time processes are operating in the overall dynamic process. In this study, a continuous-time time-to-event dynamic process is operating over a time interval [t₀, T). A change-point/state data of time-to-event dynamic process is finite. The change-point/data collection/observation times belong to the overall time-to-event operating time interval, and it is an increasing sequence {tⱼ₋₁}ⱼ₌₁^{k} of times belong to [t₀, T). This generates a finite partition (P): t₀<t₁< . . . <tⱼ₋₁<tⱼ₋₁ . . . <tₖ₋₁<tₖ=T. Moreover, a finite sequence of consecutive data observation/collection subintervals {[tⱼ₋₁, tⱼ)})ⱼ₌₁^{k} of the overall time-domain [t₀, T) of operation of state population under study and time-to-event dynamic processes. We note that the above defined finite sequence of sub-intervals covers the overall operating time-domain. It is assumed that numerical discretization, theoretical discrete-time dynamic computer readable instructions and simulation times are coordinated and synchronized with data collection/observation schedule/worksheet t{tⱼ₋₁}ⱼ₌₁^{k}.

Step-2. Real Data Coordination with Data Collection/Observation Times:

The collected/observed state data sequence under the influence of time-to-event corresponding to the increasing data collection schedule/sheet sequence {tⱼ₋₁}ⱼ₌₁^{k} of times is {zⱼ₋₁}ⱼ₌₁^{k}. Here zⱼ₋₁ is the value/realization of survival state of entities/objects/subjects at the, tⱼ₋₁ that belongs to the finite partition (P) of the overall operating common time-domain [t₀, T) of state population under the influence of binary state time-to-event dynamic processes. We denote zⱼ₋₁=Sⱼ₋₁xⱼ₋₁, where xⱼ₋₁ and Sⱼ₋₁ are size of entities and survival probability at time tⱼ₋₁, respectively. Moreover, in this study, the developed model is adapted to move the members of sub-population groups from one group to another without increasing any additional probabilistic transition state parameters and state data recording process. Instead, it is monitored by the discrete-time intervention process. It is assumed that overall size of the population of time-to-event dynamic process is k=k₀+kₙ, where kₒ and kₙ stand for the overall sizes of the sub-populations under observation and remaining susceptible sub-population at an initial time to, respectively. Subsequently, once the system is operating, at the switching time, the data management provides recorded state data up to the switching time. The study is considered to be over an interval of time [t₀, [symbol] ).

### Step-3. Data Decomposition, Reorganization and Aggregation Processes-Overall-Time Operating Domain:

It is assumed that a population with a finite number of attributes/categories/characterizations is under the influence of binary state time-to-event dynamic process. Based on the attributes/categories, the sub-population under the observation is decomposed into sub-groups of the sub-population under observation. In this study, we decompose the overall data collection/observation schedule/worksheet sequence {tⱼ₋₁}ⱼ₌₁^{k} into three overall schedule or worksheet subsequences: failure

$${\{ {t}_{{( j - 1 )}_{i - 1}}^{f} \}}_{i = 1}^{{k}_{f}} ,$$

censored

$${\{ {t}_{{( j - 1 )}_{l - 1}}^{c} \}}_{l = 1}^{{k}_{c}}$$

and admitted

$${\{ {t}_{{( j - 1 )}_{m - 1}}^{a} \}}_{m = 1}^{{k}_{a}}$$

corresponding to three types of population decomposition characterization: failure, censored and admitted sub-groups of sub-population under the observation. Corresponding to these three subgroups under observation, the collected/observed state data sequence {zⱼ₋₁}ⱼ₌₁^{k} is decomposed into three overall collected/observed state data subsequences: failure

$${\{ {z}_{{( j - 1 )}_{i - 1}}^{f} \}}_{i = 1}^{{k}_{f}} ,$$

censored

$${\{ {z}_{{( j - 1 )}_{l - 1}}^{c} \}}_{l = 1}^{{k}_{c}}$$

and admitted

$${\{ {z}_{{( j - 1 )}_{m - 1}}^{a} \}}_{m = 1}^{{k}_{a}} ,$$

under the influence of time-to-event process, where k=k_{f}+k_{c}+kₐ. In short, we associate three subsequences: failure

$${\{ {t}_{{( j - 1 )}_{i - 1}}^{f} \}}_{i = 1}^{{k}_{f}} ,$$

censored

$${\{ {t}_{{( j - 1 )}_{l - 1}}^{c} \}}_{l = 1}^{{k}_{c}}$$

and admitted

$${\{ {t}_{{( j - 1 )}_{m - 1}}^{a} \}}_{m = 1}^{{k}_{a}}$$

of sequence {tⱼ₋₁}ⱼ₌₁^{k} of times with three state data subsequences: failure

$${\{ {z}_{{( j - 1 )}_{i - 1}}^{f} \}}_{i = 1}^{{k}_{f}} ,$$

censored

$${\{ {z}_{{( j - 1 )}_{l - 1}}^{c} \}}_{l = 1}^{{k}_{c}}$$

and admitted

$${\{ {z}_{{( j - 1 )}_{m - 1}}^{a} \}}_{m = 1}^{{k}_{a}}$$

of {zⱼ₋₁}ⱼ₌₁^{k}. Furthermore, these three state sub-sequences

$${\{ {z}_{{( j - 1 )}_{i - 1}}^{f} \}}_{i = 1}^{{k}_{f}} ,$$

censored

$${\{ {z}_{{( j - 1 )}_{i - 1}}^{c} \}}_{l = 1}^{{k}_{c}}$$

and admitted

$${\{ {z}_{{( j - 1 )}_{m - 1}}^{a} \}}_{m = 1}^{{k}_{a}}$$

in the sub-population under observation are referred to as the overall failure, overall censored and overall admitted sub-sequences of the overall data sequence {zⱼ₋₁}ⱼ₌₁^{k} that corresponds to overall data collection sequence {tⱼ₋₁}=ⱼ₌₁^{k} of times in [t₀, [symbol] ).

### Step-4. Discrete-Time Operating Structural Dynamic of Time-to-Event Process-Overall State Dynamic:

We further note that the overall consecutive failure-time subsequence

$${\{ {t}_{{( j - 1 )}_{i - 1}}^{f} \}}_{i = 1}^{{k}_{f}}$$

of overall data collection schedule/worksheet sequence {tⱼ₋₁}ⱼ₌₁^{k} generates: (a) an overall failure-time sub-partition (P^{f}) of the overall partition (P), and (b) a consecutive failure-time sub-sequence

$${\{ [ {t}_{{( j - 1 )}_{i - 1}}^{f} , {t}_{{( j - 1 )}_{i}}^{f} ) \}}_{i = 1}^{{k}_{f}}$$

of operating sub-intervals of the overall sequence {[tⱼ₋₁, tⱼ)}ⱼ₌₁^{k} of operating sub-intervals of the overall time operating interval [t₀, [symbol] ). (P^{f}) is also called the consecutive failure time partition of the overall time interval [t₀, T) of the study. We note that the sub-sequence

$${\{ [ {t}_{{( j - 1 )}_{i - 1}}^{f} , {t}_{{( j - 1 )}_{i}}^{f} ) \}}_{i = 1}^{{k}_{f}}$$

of consecutive failure time operating sub-intervals covers the overall time-domain [t₀, T). Hence, it is the overall operating sequence of consecutive failure time operating subintervals over the overall operating time [t₀, [symbol] ). We already have the failure-time finite state data sub-sequence

$${\{ z ( {t}_{{( j - 1 )}_{i - 1}}^{f} ) \}}_{i = 1}^{{k}_{f}} ≡ {\{ {z}_{{( j - 1 )}_{i - 1}}^{f} \}}_{i = 1}^{{k}_{f}}$$

of the overall finite state data sequence {zⱼ₋₁}ⱼ₌₁^{k} under the influence of time-to-event process. Hence, it is the overall failure-time state data sequence on the overall continuous-time operating interval [t₀, [symbol] ). The consecutive failure-time sub-sequence

$${\{ [ {t}_{{( j - 1 )}_{i - 1}}^{f} , {t}_{{( j - 1 )}_{i}}^{f} ) \}}_{i = 1}^{{k}_{f}}$$

of sub-intervals is continuous-time operating sequence of failure-time state data sub-domains of time-to-event dynamic process. Moreover, the failure-time sub-sequence

$${\{ {z}_{{( j - 1 )}_{i - 1}}^{f} \}}_{i = 1}^{{k}_{f}}$$

of discrete-time state data provides an initial data (t₍ⱼ₋₁₎_{_{i−1}}^{f}, z₍ⱼ₋₁₎_{_{i−1}}^{f}) for transformed theoretical interconnected continuous and discrete-time hybrid dynamic systems operating over the sub-domain [t₍ⱼ₋₁₎_{_{i−1}}^{f}, t₍ⱼ₋₁₎_{ᵢ}^{f}) for j∈I(1, k) and for i∈I(1, k_{f}).

### Step-5 Data Decomposition, Reorganization and Aggregation Processes-Consecutive-Failure-Time Operating Subdomains:

We recall that the overall state data subsequences

$${\{ {z}_{{( j - 1 )}_{i - 1}}^{f} \}}_{i = 1}^{{k}_{f}} , {\{ {z}_{{( j - 1 )}_{l - 1}}^{c} \}}_{l = 1}^{{k}_{c}} and {\{ {z}_{{( j - 1 )}_{m - 1}}^{a} \}}_{m = 1}^{{k}_{a}}$$

are called overall failure, overall censored, and overall admitted state data subsequences, respectively, of {z(tⱼ₋₁)}ⱼ₌₁^{k} over the overall operating time interval [t₀, [symbol] ). We further decompose the overall censored and admitted state data subsequences over each operating consecutive failure time subinterval of the overall time interval [t₀, [symbol] ) for the subsequence{(j−1)ᵢ}ᵢ₌₁^{k}^{_{f}} of the sequence {(j−1)}ⱼ₌₁^{k}, [t₍ⱼ₋₁₎_{_{i−1}}^{f}, t₍ⱼ₋₁₎_{ᵢ}^{f}) is the (j−1)ᵢ-Th consecutive theoretical failure-time subinterval. The sequences

$${\{ {t}_{{( j - 1 )}_{{i}_{p - 1}}}^{c} \}}_{p = 1}^{{k}_{{c}_{i}}} and {\{ {t}_{{( j - 1 )}_{{i}_{q - 1}}}^{a} \}}_{q = 1}^{{k}_{{a}_{i}}}$$

are subsequences of overall theoretical censored and admitted subsequences

$${\{ {t}_{{( j - 1 )}_{l - 1}}^{c} \}}_{l = 1}^{{k}_{c}} and {\{ {t}_{{( j - 1 )}_{m - 1}}^{a} \}}_{m = 1}^{{k}_{a}} ,$$

respectively. Moreover, subsequences

$${\{ {t}_{{( j - 1 )}_{{i}_{p - 1}}}^{c} \}}_{p = 1}^{{k}_{{c}_{i}}} and {\{ {t}_{{( j - 1 )}_{{i}_{q - 1}}}^{a} \}}_{q = 1}^{{k}_{{a}_{i}}}$$

are restrictions of the overall subsequences and

$${\{ {t}_{{( j - 1 )}_{l - 1}}^{c} \}}_{l = 1}^{{k}_{c}} and {\{ {t}_{{( j - 1 )}_{m - 1}}^{a} \}}_{m = 1}^{{k}_{a}} ,$$

respectively, and are also restricted to the (j−1)ᵢ-th consecutive theoretical failure-time subinterval [t₍ⱼ₋₁₎_{_{i−1}}^{f}, t₍ⱼ₋₁₎_{ᵢ}^{f}). Based on the above relations, The two subsequences of the overall censored and/or admitted theoretical state dynamic data subsequences,

$${\{ {z}_{{( j - 1 )}_{l - 1}}^{c} \}}_{l = 1}^{{k}_{c}} and {\{ {z}_{{( j - 1 )}_{m - 1}}^{a} \}}_{m = 1}^{{k}_{a}}$$

restricted to the (j−1)ᵢ-th consecutive theoretical failure-time subinterval [t₍ⱼ₋₁₎_{_{i−1}}^{f}, t₍ⱼ₋₁₎_{ᵢ}^{f}) are as:

$${\{ {z}_{{( j - 1 )}_{p - 1}}^{c} \}}_{p = 1}^{{k}_{{c}_{i}}} and {\{ {z}_{{( j - 1 )}_{q - 1}}^{a} \}}_{q = 1}^{{k}_{{a}_{i}}} ,$$

respectively. From this, we have two restriction sequences

$${\{ {z}_{{( j - 1 )}_{{( i - 1 )}_{p - 1}}}^{c} \}}_{p = 1}^{{k}_{{c}_{i}}} and {\{ {z}_{{( j - 1 )}_{{( i - 1 )}_{p - 1}}}^{a} \}}_{q = 1}^{{k}_{{a}_{i}}} of {\{ {z}_{{( j - 1 )}_{l - 1}}^{c} \}}_{l = 1}^{{k}_{c}} and {\{ {z}_{{( j - 1 )}_{m - 1}}^{a} \}}_{m = 1}^{{k}_{a}} ,$$

respectively. This is valid for each i∈I(1, k). Hence, the terms of both of the sequences

$${\{ {\{ {z}_{{( j - 1 )}_{{( i - 1 )}_{p - 1}}}^{c} \}}_{p = 1}^{{k}_{{c}_{i}}} \}}_{i = 1}^{{k}_{f}} and {\{ {\{ {z}_{{( j - 1 )}_{{( i - 1 )}_{q - 1}}}^{a} \}}_{q = 1}^{{k}_{{a}_{i}}} \}}_{i = 1}^{{k}_{f}}$$

are restricted to terms of sequence

$${\{ [ {t}_{{( j - 1 )}_{i - 1}}^{f} , {t}_{{( j - 1 )}_{i}}^{f} ) \}}_{i = 1}^{{k}_{f}}$$

of consecutive failure-time sequence of operating sub-intervals of time interval [t₀, [symbol] ), where k_{c}=Σᵢ₌₁^{k}^{_{f}} k_{c}_{ᵢ} and kₐ=Σᵢ₌₁^{k}^{_{f}} kₐ_{ᵢ}. Here the subsequences

$${\{ {( j - 1 )}_{{( i - 1 )}_{p - 1}} \}}_{p = 1}^{{k}_{{c}_{i}}} and {\{ {( j - 1 )}_{{( i - 1 )}_{p - 1}} \}}_{q = 1}^{{k}_{{a}_{i}}}$$

are subsequences of the {(j−1)ᵢ₋₁}ᵢ₌₁^{k}^{_{f}}, respectively.

### Step-6. Conceptual Parameter Estimation Process:

The developed patentable software device addresses two major problems of interest in time-to-event dynamic processes, namely: (1) Survival state and (2) Change point state estimation analysis problems. These two problems conceptually and operationally are identical. In view of this, it is enough to devote description about the survival state statistical problem in details. The Interconnected Dynamic Model for Time-to-Event Data Statistic 120 (1^{st} Stage) is the INIL technological component of the Interconnected Nonlinear Hybrid Dynamic Model for Time-to-Event Process 105. The Innovative Interconnected Discrete-Time Dynamic Model for Nonlinear Time-to-Event Statistical Data Analysis 125 (2^{nd} Stage), is the overall technological component of the Interconnected Nonlinear Hybrid Dynamic Model for Time-to-Event Process 105. The presented Modified Local Lagged Adapted Generalized Method of Moments is indeed Innovative Interconnected Discrete-time Dynamic Model for Nonlinear Time-to-Event Statistical Data Analysis 125. The Innovative Interconnected Discrete-time Dynamic Model for Nonlinear Time-to-Event Statistical Data Analysis 125 is the coupled version of the Interconnected Dynamic Model for Time-to-Event Data Statistic 120 and the Local Lagged Adapted Generalized Method of Moments. Moreover, Interconnected Dynamic Model for Time-to-Event Data Statistic 120 is a special case of Innovative Interconnected Discrete-time Dynamic Model for Nonlinear Time-to-Event Statistical Data Analysis 125. The System and Method for Nonlinear Time-to-Event Statistical Data Analysis 100 is built in with the functioning/operating characteristic for technological components Interconnected Dynamic Model for Time-to-Event Data Statistic 120 and Innovative Interconnected Discrete-time Dynamic Model for Nonlinear Time-to-Event Statistical Data Analysis 125 of Interconnected Nonlinear Hybrid Dynamic Model for Time-to-Event Process 105. Based on this, there is one and only one technological device, “software”. The System and Method for Nonlinear Time-to-Event Statistical Data Analysis 100 can be used/operated in series. For this purpose, first, we present an overall conceptual parameter estimation process in two stages: Stage-1. Interconnected Dynamic Model for Time-to-Event Data Statistic 120, and Stage-2. Innovative Interconnected Discrete-time Dynamic Model for Nonlinear Time-to-Event Statistical Data Analysis 125 approaches. They are outlined below.

### Stage-1. Interconnected Dynamic Model for Time-to-Event Data Statistic Approach Based Conceptual Parameter Estimation Process-I:

We note that Interconnected Dynamic Model for Time-to-Event Data Statistic 120 is local and single shot device. It is centered around each (j−1)ᵢ-th consecutive pair of ordered failure-time interval [t₍ⱼ₋₁₎_{_{i−1}}^{f}, t₍ⱼ₋₁₎_{ᵢ}^{f}) with its right-end-censored data/observation/collection for i∈I(1, k_{f}), where (j−1)ᵢ is the (j−1)ᵢ−th term of the subsequence {(j−1)ᵢ}ᵢ₌₁^{k}^{_{f}} of the sequence {(j−1)}ᵢ₌₁^{k}. In fact, this type of parameter/state estimation problem in time-to-event processes can be characterized by “the local single-shot procedure/method” based on the right-end point of the (j−1)ᵢ-th consecutive failure or change point subinterval for each i∈I(1, k_{f}). Based on the coordination of operation of the Euler-type numerical approximation scheme, theoretical discretization and simulation processes with data collection schedule/worksheet, the coordination of time and corresponding finite state data in Steps-1 to 5 form computer readable information/instructions. These computer readable instructions applicable for the operation of Interconnected Dynamic Model for Time-to-Event Data Statistic 120 and Innovative Interconnected Discrete-time Dynamic Model for Nonlinear Time-to-Event Statistical Data Analysis 125. In fact, there is one-to-one onto transformation (isomorphism)⇔(data size and order preserving function) between the finite data collection schedule/worksheet and corresponding well-defined finite state data drawn sequences/subsequences (Sequence is function) even if a state data is repeated. This is due to the fact that the data collection finite time schedule forms a finite increasing sequence of time. Moreover, overall partition (P) of k points and partition (P^{f}) of consecutive failure points k_{f} of respective operating common time domains that is associated with corresponding increasing sequences of times. In addition, I(1, k)⇔{tⱼ)}=ⱼ₌₁^{k} ⇔{z(tⱼ)}ⱼ₌₁^{k} and I(1, k_{f})⇔{tⱼ₋₁ᵢ₋₁^{f}}ᵢ₌₁^{k}^{_{f}} ⇔{zⱼ₋₁ᵢ₋₁^{f}}ᵢ₌₁^{k}^{_{f=. Substituting a given/obtained time-to-event statistical data corresponding to the given/obtained time-to-event dynamic process under external/internal intervention process into the developed Discrete Time Interconnected Conceptual/Theoretical State Observation Dynamic Model 115, a discrete-time statistic state system observation dynamic process is developed, which is a simplified version of Discrete-Time Wiener-Kalman-type Interconnected Statistic State and Observation Dynamic Process. The Discrete-Time Wiener-Kalman-type Interconnected Statistic State and Observation Dynamic Process is indeed a computer readable discrete-time dynamic instruction process for the Interconnected Dynamic Model for Time-to-Event Data Statistic 120.}}

### Stage-2. Innovative Interconnected Discrete-Time Dynamic Model for Nonlinear Time-to-Event Statistical Data Analysis Approach Based Conceptual Parameter Estimation Process-H:

We recall that Innovative Interconnected Discrete-time Dynamic Model for Nonlinear Time-to-Event Statistical Data Analysis 125 is the coupled version of the Interconnected Dynamic Model for Time-to-Event Data Statistic 120 and the Local Lagged Adapted Generalized Method of Moments. Moreover, any ordered transformation of a finite data collection schedule/worksheet is isomorphic to a finite ordered state data value/sequence. The development of the Innovative Interconnected Discrete-time Dynamic Model for Nonlinear Time-to-Event Statistical Data Analysis 125 approach is based on following two steps: Step-8. Development of Discrete-time Conceptual Computer Readable Dynamic Information for Innovative Interconnected Discrete-time Dynamic Model for Nonlinear Time-to-Event Statistical Data Analysis 125, and Step-9. Development of Discrete-time Conceptual Computer Readable Dynamic Parameter Estimation Instruction System for Innovative Interconnected Discrete-time Dynamic Model for Nonlinear Time-to-Event Statistical Data Analysis 125. These steps are described below:

### Step-8. Development of Discrete-Time Conceptual Computer Readable Dynamic Information for Innovative Interconnected Discrete-Time Dynamic Model for Nonlinear Time-to-Event Statistical Data Analysis 125:

For the development of computer readable information, we systematically outline a few fundamental ideas and results. The basis for these ideas are centered on ordered transformations of a finite data collection schedule/worksheet that is isomorphic to a finite ordered state data value/sequence. For example, for each j∈I(1, k) and i∈I(1, k_{f}), we define as increasing subsequence {iₗ}ₗ₌₀ⁱ⁻¹ (with iₗ=1, and range is I₀(i−1)) of the increasing sequence {i}ᵢ₌₁^{k}^{_{f}} (with k_{f}(i)=i, and range is I₁(k_{f})=I(1, k_{f})). Moreover, these sequences are denoted by {iₗ}ₗ₌₀ⁱ⁻¹=I₀ⁱ⁻¹ and {i}ᵢ₌₁^{k}^{_{f}}=I₁^{k}^{_{f}}, and I denotes for identity map/sequence. In the light of these notations and definitions, we conclude that I₀ⁱ⁻¹ is restriction of I₀^{f}. For each i∈I(1, k_{f}), we define a sequence mᵢ=F on I₀(i−1) into I₁(k_{f}) as: mᵢ(l)=mᵢ(iₗ)=F(iₗ)=(iₗ+1), for each iₗ∈I₀(i−1). I₀(i−1)={0, 1, . . . , l, . . . , i−1}⇔{1, . . . , l, . . . , i}=I₁(i). For fixed iₗ∈I₀(i−1), mᵢ(iₗ)=mᵢ(l)∈I₁(i)=R(mᵢ), we associate a finite increasing sequence of magnitude of nontrivial time delay generated by mᵢ(iₗ)=iₗ+1 as:

$$\{ 1 , 2 , … , l , … , {m}_{i} ( {i}_{l} ) - 1 , {m}_{i} ( {i}_{l} ) \} ⇔ \{ 0 , 1 , … , {B}^{r} F ( {l}_{i} ) … , {B}^{2} F ( {i}_{l} ) , BF ( {i}_{l} ) \} ⇔ {I}_{0}^{{i}_{l} - 1} = {\{ {i}_{{l}_{r}} \}}_{r = 0}^{{i}_{l} - 1} ⇔ {I}_{- {i}_{l} + 1}^{0} = {I}_{- {m}_{i} + 1}^{0}$$

where B (the backward shift operator) is the inverse of F; mᵢ(iₗ)=mᵢ, and “moving mᵢ means/average” (notational understanding and mathematical justifications in the context of the usage of the term) mᵢ is the sequence I₋ₘ_{ᵢ}₊₁⁰ corresponding to fixed iₗ (fixed i), mᵢ (iₗ) generates all admissible nontrivial magnitudes of delays that are less than or equal to delays. We further note that the: (1) I₀ⁱ^{ₗ}⁻¹, I₀ⁱ⁻¹ and I₀^{k}^{_{f}} form nested subsequences of the overall sequence of data collection schedule/worksheet I₀^{k} over the overall operating time interval [t₀, [symbol] ), and (2) R(I₀ⁱ^{ₗ}⁻¹)=I₀(iₗ−1), R(I₀ⁱ⁻¹)=I₀(i−1) and R(I₀^{k}^{_{f}})=I₀(k_{f})=(P^{f})) form nested sub-partitions of the partition (P) of the overall operating time interval [t₀, [symbol] ), and (3) I₀ⁱ^{ₗ}⁻¹, I₀ⁱ⁻¹ and I₀^{k}^{_{f}} are nested restricted subsequences of overall sequence of data collection schedule/worksheet I₀^{k} over the overall operating time interval [t₀, [symbol] ). From the above discussion, we recall the definitions: A partition of closed interval [t₍ⱼ₋₁₎_{ᵢ}₋ₘ_{ᵢ}^{f}, t₍ⱼ₋₁₎_{ᵢ}^{f}] is called local lagged failure-time partition at a failure-time t₍ⱼ₋₁₎_{ᵢ}^{f}, and it is defined by:

$${P}_{{( j - 1 )}_{i - {m}_{i}}}^{f} ∷ = {t}_{{( j - 1 )}_{i - {m}_{i}}}^{f} < {t}_{{( j - 1 )}_{i - {m}_{i} + 1}}^{f} < ⋯ < {t}_{{( j - 1 )}_{i - 1}}^{f} < {t}_{{( j - 1 )}_{i}}^{f} .$$

A mᵢ-size of consecutive ordered failure time sub-interval subsequence {[t₍ⱼ₋₁₎_{_{i−1+l}}^{f}, t₍ⱼ₋₁₎_{ᵢ₊ₗ}^{f})}ₗ₌₋ₘ_{ᵢ}₊₁⁰ of the overall consecutive ordered failure time subinterval sequence {[t₍ⱼ₋₁₎_{_{i−1}}^{f}, t₍ⱼ₋₁₎_{ᵢ}^{f})}ᵢ₌₁^{k}^{_{f}} is called local lagged discrete-time dynamic (moving) subsequence of consecutive failure-time subintervals at t₍ⱼ₋₁₎_{ᵢ}^{f}. Moreover, it is finite covering of

$$[ {t}_{{( j - 1 )}_{i - {m}_{i}}}^{f} , {t}_{{( j - 1 )}_{i}}^{f} ) ,$$

that is,

$${⋃}_{l = - {m}_{i} + 1}^{0} [ {t}_{{( j - 1 )}_{i - 1 + l}}^{f} , {t}_{{( j - 1 )}_{i + l}}^{f} ) = [ {t}_{{( j - 1 )}_{i - {m}_{i}}}^{f} , {t}_{{( j - 1 )}_{i}}^{f} )$$

for mᵢ∈I₁(i). We note that I₀(i−1) ⇔I₁(i). P^{f} is the partition associated with the overall failure-time data sequence {z₍ⱼ₋₁₎_{_{i−1}}}ᵢ₌₁^{k}^{_{f}} and

$${P}_{{( j - 1 )}_{i - {m}_{i}}}^{f}$$

is the sub-partition associated with the subsequence

$${s}_{{m}_{i} , {( j - 1 )}_{i}} = {\{ {F}^{l} {z}_{{( j - 1 )}_{i - 1 + l}}^{f} \}}_{l = - {m}_{i} + 1}^{1} .$$

The change of survivals states

$${\{ {F}^{l} ( {z}_{{( j - 1 )}_{i + 1}}^{f} - {z}_{{( j - 1 )}_{i - 1 + {l}^{l }}}^{f} ) \}}_{l = - {m}_{i} + 1}^{0}$$

is subsequence over the consecutive ordered failure time subinterval subsequence ([t₍ⱼ₋₁₎_{_{i−1+l}}^{f}, t₍ⱼ₋₁₎_{ᵢ₊ₗ}^{f})}=ₗ₌₋ₘ_{ᵢ}₊₁⁰.

### Step-9. Development Discrete-Time Conceptual Computer Readable Dynamic Parameter Estimation Instruction System for Innovative Interconnected Discrete-Time Dynamic Model for Nonlinear Time-to-Event Statistical Data Analysis 125:

Employing, the basic conceptual computer readable information regarding the Innovative Interconnected Discrete-time Dynamic Model for Nonlinear Time-to-Event Statistical Data Analysis 125, we systematically provide the conceptual computer readable discrete-time dynamic instructions for Innovative Interconnected Discrete-time Dynamic Model for Nonlinear Time-to-Event Statistical Data Analysis 125. For the sake of continuity, we recall that for each i∈I(1, k_{f}) and j∈I(1, n), t₍ⱼ₋₁₎_{ᵢ}^{f} is a failure scheduled time clock with the overall data collection schedule/worksheet time sequence. t₍ⱼ₋₁₎_{ᵢ} is the (j−1)ᵢ-th term synchronized with the failure data collection sub-schedule/worksheet

$${\{ {t}_{{( j - 1 )}_{i}}^{f} \}}_{i = 1}^{{k}_{f}}$$

which is the overall data collection schedule/worksheet {(tⱼ₋₁}ⱼ₌₁^{k}, i∈I(1, k_{f}). From the simulation process time in relation with the real data observation schedule (Innovative Interconnected Discrete-time Dynamic Model for Nonlinear Time-to-Event Statistical Data Analysis 125), we have mᵢ∈OS₍ⱼ₋₁₎_{ᵢ}=I₁(i)=I(1, i) at t₍ⱼ₋₁₎_{ᵢ}^{f}. Therefore, we pick a local admissible sequence of discrete-time delay mᵢ∈OS₍ⱼ₋₁₎_{ᵢ} and determine {F^{l}z₍ⱼ₋₁₎_{_{i−1+l}}}ₗ₌₋ₘ_{ᵢ}₊₁⁰ a finite data subsequence for each with iₗ=1, l∈I₋ₘ_{ᵢ}₊₁⁰={−mᵢ+1, . . . , −mᵢ+l, . . . , −1, 0} at the right-end point of each consecutive failure-time oerating subintervals [t₍ⱼ₋₁₎_{_{i−1+l}}^{f}, t₍ⱼ₋₁₎_{ᵢ}₊₁^{f}). Using this procedure, we obtain the local admissible collection of restricted data subsequences AS₍ⱼ₋₁₎_{ᵢ}={zₘ_{ᵢ}_{,(j-1)}_{ᵢ}:mᵢ∈I(1, i)} for each i∈I(1, k_{f}). Based on this admissible collection of data sequences at t₍ⱼ₋₁₎_{ᵢ}^{f} and the discrete-time interconnected conceptual/theoretical state observation dynamic model Discrete Time Interconnected Conceptual/Theoretical State Observation Dynamic Model 115, we determine, finite local sequence of parameter estimates at t₍ⱼ₋₁₎_{ᵢ} corresponding to the member of admissible data sequence in AS₍ⱼ₋₁₎_{ᵢ}. We complete this process based on the Principle of Mathematical Induction. We symbolically summarize the discrete-time computer readable dynamic instructions for state parameter procedure as follows:

$${m}_{i} ∈ {OS}_{{( j - 1 )}_{i}} ⇔ {I}_{0} ( i - 1 ) ⇔ {AS}_{{( j - 1 )}_{i}} ⇔ \{ 1 , … , {m}_{i} , … , i \} ⇔ {\{ {\hat{λ}}_{{m}_{i} , {( j - 1 )}_{i}} , {\hat{σ}}_{{m}_{i} , {( j - 1 )}_{i}} \}}_{{m}_{i} ∈ {OS}_{{( j - 1 )}_{i}}} ⇔ {\{ [ {t}_{j - 1 i - 1 + l}^{f} , {t}_{j - 1 i + l}^{f} ) \}}_{l = - {m}_{i} + 1}^{0} .$$

### Step-7. Conceptual State Estimation Scheme:

Here, we use the conceptual based parameter estimates. In fact, for each i∈(1, k_{f}), all discrete-time conceptual computational dynamic computer readable information and parameter estimation procedures are used for continuous and discrete-time real world data sets, respectively. As we stated before, the Innovative Interconnected Discrete-time Dynamic Model for Nonlinear Time-to-Event Statistical Data Analysis 125 is a coupled version of Interconnected Dynamic Model for Time-to-Event Data Statistic 120 and Local Lagged Adapted Generalized Method of Moments. Here too, the development of the overall conceptual state estimation scheme is based on two stages: Stage-1. Development of Discrete-time Conceptual Computational Computer Readable Dynamic State Estimation Information for Interconnected Dynamic Model for Time-to-Event Data Statistic 120, and Stage-2. Development of Discrete-time Conceptual Computational Computer Readable Dynamic State Estimation Instruction System for Innovative Interconnected Discrete-time Dynamic Model for Nonlinear Time-to-Event Statistical Data Analysis 125. These steps are described below:

### Stage-1. Development of Discrete-Time Conceptual Computational Computer Readable Dynamic State Estimation Information for Interconnected Dynamic Model for Time-to-Event Data Statistic 120:

The step-by-step parameter estimates at t₍ⱼ₋₁₎_{ᵢ}^{f} are based on the Discrete Time Interconnected Conceptual/Theoretical State Observation Dynamic Model 115, a discrete-time statistic state system observation dynamic process and the Discrete-Time Wiener-Kalman-type Interconnected Statistic State and Observation Dynamic Process. The Discrete-Time Wiener-Kalman-type Interconnected Statistic State and Observation Dynamic Process is indeed a computer readable discrete-time dynamic instruction process for the Interconnected Dynamic Model for Time-to-Event Data Statistic 120. The developed device is based on the correctness of mathematical reasoning and fundamental properties of dynamic models, that is, the continuous dependence of solution process of continuous-time dynamic system, using an initial relative frequency of a given data set (This assists to identify the initial state size), a choice of initial time and initial value S₀ is made. In fact, the solution process of time-to-event dynamic model is increasing with respect to S₀. Based on the above specifications, the optimal choice of initial value S₀ is determined on the stability of the mean-square deviation of the states corresponding to the choice of the initial value S₀.

### Stage-2. Development Discrete-Time Conceptual Computational Computer Readable Dynamic State Estimation Instruction System for Innovative Interconnected Discrete-Time Dynamic Model for Nonlinear Time-to-Event Statistical Data Analysis 125:

We recall that the basis for the computer readable discrete-time dynamic instruction process for the Interconnected Dynamic Model for Time-to-Event Data Statistic 120 is based on parameter and state estimates at each t₍ⱼ₋₁₎_{ᵢ}^{f} right-end point of consecutive pair of ordered failure or change time subinterval of operation of the time-to-event dynamic process. This process of estimating parameter and state at t₍ⱼ₋₁₎_{ᵢ}^{f} is further extended to each mL-size local lagged ordered consecutive failure-time subinterval subsequence at t₍ⱼ₋₁₎_{ᵢ}^{f}. In fact, we determine the Discrete-Time Wiener-Kalman-type Interconnected Statistic State and Observation Dynamic Process for the Innovative Interconnected Discrete-time Dynamic Model for Nonlinear Time-to-Event Statistical Data Analysis 125 over the union of consecutive failure-time subintervals

$${\{ [ {t}_{{( j - 1 )}_{i - 1 + l}}^{f} , {t}_{{( j - 1 )}_{i + l}}^{f} ) \}}_{l = - {m}_{i} + 1}^{0} = [ {t}_{{( j - 1 )}_{i - {m}_{i}}}^{f} , {t}_{{( j - 1 )}_{i}}^{f} )$$

that is based on the aggregation of the Interconnected Dynamic Model for Time-to-Event Data Statistic 120 computer readable information over each consecutive failure interval [t₍ⱼ₋₁₎_{_{i−1+l}}^{f}, t₍ⱼ₋₁₎_{ᵢ₊ₗ}^{f}) for l∈I₋ₘ_{ᵢ}₊₁⁰, and each mᵢ∈OS₍ⱼ₋₁₎_{ᵢ}. Again, all step-by-step procedures developed parameter estimates at t₍ⱼ₋₁₎_{ᵢ}^{f} are determined using Discrete Time Interconnected Conceptual/Theoretical State Observation Dynamic Model 115, discrete-time statistic state system observation dynamic process for each i∈(1, k_{f}). We symbolically summarize the discrete-time computer readable dynamic instructions for

$${m}_{i} ∈ {OS}_{{( j - 1 )}_{i}} ⇔ {AS}_{{( j - 1 )}_{i}} ⇔ {\{ {\hat{S}}_{{m}_{i} , {( j - 1 )}_{i}} \}}_{{m}_{i} ∈ {OS}_{{( j - 1 )}_{i}}} ⇔ {\{ {\hat{λ}}_{{m}_{i} , ( j - 1 ) i} {\hat{σ}}_{{m}_{i} , {( j - 1 )}_{i}} \}}_{{m}_{i} ∈ {OS}_{{( j - 1 )}_{i}}} .$$

### Simulation Based State Estimates for Hybrid Nonlinear Time-to-Event Process-Interconnected Dynamic Model for Time-to-Event Data Statistic 120:

Up to this stage, state data sets and its subsets were conceptual data sets. Hereafter, we will be considering real time data sets and its subsets. First, we organize/coordinate the real data set in the framework of the conceptual data set, and then substitute the real data set for the conceptual data. Moreover, for i∈(1, k_{f}), all discrete-time conceptual computational dynamic computer readable information and the conceptual parameter and state estimation steps are used for in the context real world data sets. The resulting parameter and state estimate data are recorded.

As we stated before, the Innovative Interconnected Discrete-time Dynamic Model for Nonlinear Time-to-Event Statistical Data Analysis 125 is a coupled version of the Interconnected Dynamic Model for Time-to-Event Data Statistic 120 and the Local Lagged Adapted Generalized Method of Moments. Here too, we develop the two real state data estimate versions of the Interconnected Dynamic Model for Time-to-Event Data Statistic 120 and Innovative Interconnected Discrete-time Dynamic Model for Nonlinear Time-to-Event Statistical Data Analysis 125: (1) Interconnected Dynamic Model for Time-to-Event Data Statistic 120 based state estimate is local and “single shot” at the right-end point of each ordered two consecutive failure time operating subinterval of the overall operating interval [t₀, [symbol] ). (2) Innovative Interconnected Discrete-time Dynamic Model for Nonlinear Time-to-Event Statistical Data Analysis 125 based state estimate is “discrete-time dynamic process. Further details about the Innovative Interconnected Discrete-time Dynamic Model for Nonlinear Time-to-Event Statistical Data Analysis 125 are outlined below:

### Single Shot: Simulation Based Discrete-Time State Estimates for Hybrid Nonlinear Time-to-Event Process—Innovative Interconnected Discrete-Time Dynamic Model for Nonlinear Time-to-Event Statistical Data Analysis 125:

Innovative Interconnected Discrete-time Dynamic Model for Nonlinear Time-to-Event Statistical Data Analysis 125 based real state data estimate over the union of consecutive failure-time subintervals

$${\{ [ {t}_{j - 1 i - 1 + l}^{f} , {t}_{j - 1 i + l}^{f} ) \}}_{l = - {m}_{i} + 1}^{0} = [ {t}_{{( j - 1 )}_{i - {m}_{i}}}^{f} , {t}_{{( j - 1 )}_{i}}^{f} )$$

is the aggregation of Interconnected Dynamic Model for Time-to-Event Data Statistic 120 based real local single shot data estimates over each consecutive failure interval [tⱼ₋₁ᵢ₋₁₊ₗ, tⱼ₋₁ᵢ₊ₗ^{f}) for l∈I₋ₘ_{ᵢ}₊₁⁰, and each mᵢ∈OS₍ⱼ₋₁₎_{ᵢ} at t₍ⱼ₋₁₎_{ᵢ}^{f}. This simulation procedure generates mᵢ-local admissible sequence of simulated data estimates corresponding to the mᵢ-AS₍ⱼ₋₁₎_{ᵢ} sequence of local admissible lagged adapted finite sequences of conditional observation sample/data observation size mᵢ at t₍ⱼ₋₁₎_{ᵢ}^{f}. For each mᵢ∈OS₍ⱼ₋₁₎_{ᵢ}, generates admissible sequence of real state data estimates based on the Discrete-Time Wiener-Kalman-type Interconnected Statistic State and Observation Dynamic Process in the context of Innovative Interconnected Discrete-time Dynamic Model for Nonlinear Time-to-Event Statistical Data Analysis 125. The Discrete-Time Wiener-Kalman-type Interconnected Statistic State and Observation Dynamic Process is indeed a computer readable discrete-time dynamic instruction dynamic process (CRDTDIP) for the Innovative Interconnected Discrete-time Dynamic Model for Nonlinear Time-to-Event Statistical Data Analysis 125. The developed device is based on the correctness of mathematical reasoning and basic fundamental properties of dynamic models, that is, the continuous dependence of solution process of continuous-time dynamic system, using an initial relative frequency of a given data set (this assists to identify the initial size), a choice of initial time and initial value S₀ is made. In fact, the solution process of time-to-event dynamic model is increasing with respect to S₀. In view of this, the optimal choice of initial value S₀ is based on the stability of the mean-square deviation of the states corresponding to the choice of the initial value S₀ and given data as follows

$${m}_{i} ∈ {OS}_{{( j - 1 )}_{i}} ⇔ {AS}_{{( j - 1 )}_{i}} ⇔ {\{ {\hat{z}}_{{m}_{i} , {( j - 1 )}_{i}} \}}_{{m}_{i} ∈ {OS}_{{( j - 1 )}_{i}}} ⇔ {\{ {\hat{λ}}_{{m}_{i} , ( j - 1 ) i} {\hat{σ}}_{{{m}_{i} ( j - 1 )}_{i}} \}}_{{m}_{i} ∈ {OS}_{{( j - 1 )}_{i}}} .$$

### Mean-Square Sub-Optimal Estimate—Innovative Interconnected Discrete-Time Dynamic Model for Nonlinear Time-to-Event Statistical Data Analysis 125:

The Innovative Interconnected Discrete-time Dynamic Model for Nonlinear Time-to-Event Statistical Data Analysis 125 based state and parameter estimation problems for nonlinear, nonstationary hybrid dynamic time-to-event process provides a finite admissible state data estimates at each at each t₍ⱼ₋₁₎_{ᵢ} failure time. Using quadratic-mean error relative to the conditional expectation of data subject sub-sigma algebra and simulated real data estimate at t₍ⱼ₋₁₎_{ᵢ}^{f} under pre-assigned positive number ε>0, we determine the following sub-optimal admissible set of size of moving average at t₍ⱼ₋₁₎_{ᵢ}^{f} as:

$${ℳ}_{{( j - 1 )}_{i}} = \{ {m}_{i} \text{:} {Ξ}_{{m}_{i} , {( j - 1 )}_{i} , {z}_{{( j - 1 )}_{i }} \}} < ɛ for {m}_{i} ∈ {OS}_{{( j - 1 )}_{i}} \} ,$$

where

$${Ξ}_{{m}_{i} , {( j - 1 )}_{i} , {z}_{{( j - 1 )}_{i}}} = {( z ( {t}_{{( j - 1 )}_{i}}^{f} ) - {z}_{{m}_{i} , {( - 1 )}_{i}}^{s} )}^{2} .$$

Among these collected sub-optimal sets of values [symbol] ₍ⱼ₋₁₎_{ᵢ}, the value that gives the minimum

$${Ξ}_{{m}_{i} , {( j - 1 )}_{i} , {z}_{{( j - 1 )}_{i}}}$$

is recorded as \hat{m}ᵢ. The size parameters corresponding to \hat{m}ᵢ are referred as the ε-level sub-optimal estimates of the true parameters. These sub-optimal estimates are estimated at time t₍ⱼ₋₁₎_{ᵢ}^{f} with \hat{m}ᵢ. The simulated value

$${z}_{{\hat{m}}_{i} , {( j - 1 )}_{i}}^{s} at {t}_{{( j - 1 )}_{i}}^{f}$$

corresponding to \hat{m}ᵢ is recorded as the best sub-optimal estimate for dynamic state z((j−1)ᵢ) at t₍ⱼ₋₁₎₎_{ᵢ}. Having obtained the best estimate for λ and σ², we then proceed to find the best sub-optimal estimate for the survival state function at t₍ⱼ₋₁₎_{ᵢ}, via the following discrete-time simulation dynamic process. Finally, an estimate of S_{\hat{m}}_{ᵢ}_{,(j-1)}_{ᵢ} at t₍ⱼ₋₁₎_{ᵢ}^{f} corresponding to \hat{m}ᵢ is also recorded as the best estimate for survival state S₍ₜ₍ⱼ₋₁₎_{ᵢ}) at t₍ⱼ₋₁₎_{ᵢ}^{f}

$$\{ \begin{matrix}𝔼 [ Δ {z}_{j - 1 i} \vert {𝒢}_{j - 1 i - 1} ] = - λ ( {T}_{j - 1 i - 1}^{f} , {S}_{j - 1 i - 1} ) [ {\sum }_{l = 1}^{{k}_{{b}_{i}} + 1} z ( {T}_{j - 1 i - 1 l - 1}^{c / a} ) Δ {T}_{j - 1 i - 1 l}^{c / a} ] + \\ {Γ}_{ji}^{no} - {k}_{{c}_{i}} + {k}_{{a}_{i}} , z ( {t}_{0} ) = {z}_{0} , \\ 𝔼 [ Δ V ( {T}_{j - 1 i}^{f} , {z}_{j - 1 i} ) \vert {𝒢}_{j - 1 i - 1} ] = {\sum }_{l = 1}^{{k}_{{b}_{i}} + 1} \frac{\partial }{\partial t} V ( {T}_{j - 1 i - 1 l - 1}^{c / a} , z ( {T}_{j - 1 i - 1 l - 1}^{c / a} ) ) Δ {T}_{j - 1 i - 1 l}^{c / a} - \\ λ ( {T}_{j - 1 l - 1}^{f} , {S}_{j - 1 i - 1} ) [ {\sum }_{l = 1}^{{k}_{{b}_{i}} + 1} z ( {T}_{j - 1 i - 1 l - 1}^{c / a} ) \frac{\partial }{\partial z} V ( \begin{matrix}{T}_{j - 1 i - 1 l - 1}^{c / a} , \\ z ( {T}_{j - 1 i - 1 l - 1}^{c / a} )\end{matrix} ) Δ {T}_{j - 1 i - 1 l}^{c / a} ] + \\ \frac{1}{2} {σ}^{2} ( {T}_{j - 1 i - 1}^{f} , {S}_{j - 1 i - 1} ) [ {\sum }_{l = 1}^{{k}_{{b}_{i}} + 1} {z}^{2} ( {T}_{j - 1 i - 1 l - 1}^{\frac{c}{a}} ) \frac{{\partial }^{2}}{\partial {z}^{2}} V ( {T}_{j - 1 i - 1 l - 1}^{\frac{c}{a}} , z ( {T}_{j - 1 i - 1 l}^{\frac{c}{a}} ) ) Δ {T}_{j - 1 i - 1 l}^{\frac{c}{a}} ] + \\ {Γ}_{ji}^{nov} - {k}_{{c}_{i}}^{cv} + {k}_{{a}_{i}}^{av} , \\ Δ {S}_{j - 1 i} = - {S}_{j - 1 i - 1} λ ( {T}_{j - 1 i - 1}^{f} , {S}_{j - 1 i - 1} ) Δ {T}_{j - 1 i}^{f} + {S}_{j - 1 i - 1} σ ( {T}_{j - 1 i - 1}^{f} , {S}_{j - 1 i - 1} ) Δ w ( {T}_{j - 1 i}^{f} ) , S ( {T}_{0} ) = {S}_{0} ,\end{matrix}$$

$$\{ \begin{matrix}𝔼 [ Δ {z}_{j - 1 r} \vert {𝒢}_{j - 1 r - 1} ] = - λ ( {T}_{j - 1 r - 1}^{cp} , {S}_{j - 1 r - 1} ) [ {\sum }_{l = 1}^{{k}_{{b}_{r}} + 1} z ( {T}_{j - 1 r - 1 l - 1}^{f / c / a} ) Δ {T}_{j - 1 r - 1 l}^{f / c / a} ] + \\ {Γ}_{jr}^{no} - {k}_{{f}_{r}} - {k}_{{c}_{r}} + {k}_{{a}_{r}} , z ( {T}_{0} ) = {z}_{0} , \\ 𝔼 [ Δ V ( {T}_{j - 1 r}^{cp} , {z}_{j - 1 r} ) \vert {𝒢}_{j - 1 r - 1} ] = {\sum }_{l = 1}^{{k}_{{b}_{r}} + 1} \frac{\partial }{\partial t} V ( {T}_{j - 1 r - 1 l - 1}^{f / c / a} , z ( {T}_{j - 1 r - 1 l - 1}^{f / c / a} ) ) \\ Δ {T}_{j - 1 r - 1 l}^{f / c / a} - λ ( {T}_{j - 1 r - 1}^{cp} , {S}_{j - 1 r - 1} ) [ {\sum }_{l = 1}^{{k}_{{b}_{i}} + 1} z ( {T}_{j - 1 r - 1 l - 1}^{f / c / a} ) \frac{\partial }{\partial z} V ( \begin{matrix}{T}_{j - 1 r - 1 l - 1}^{f / c / a} , \\ z ( {T}_{j - 1 r - 1 l - 1}^{f / c / a} )\end{matrix} ) Δ {T}_{j - 1 r - 1 l}^{f / c / a} ] + \\ {Γ}_{jr}^{nov} - {k}_{{f}_{r}}^{fv} + {k}_{{c}_{r}}^{cv} \\ \frac{1}{2} {σ}^{2} ( {T}_{j - 1 r - 1}^{cp} , {S}_{j - 1 r - 1} ) [ {\sum }_{l = 1}^{{k}_{{b}_{r}} + 1} {z}^{2} ( {T}_{j - 1 r - 1 l - 1}^{c / a} ) \frac{{\partial }^{2}}{\partial {z}^{2}} V ( {T}_{j - 1 r - 1 l - 1}^{f / c / a} , z ( {T}_{j - 1 r - 1 l - 1}^{f / c / a} ) ) Δ {T}_{j - 1 r - 1 l}^{f / c / a} ] + {k}_{{a}_{r}}^{av} \\ Δ {S}_{j - 1 r} = - {S}_{j - 1 r - 1} λ ( {T}_{j - 1 r - 1}^{cp} , {S}_{j - 1 r - 1} ) Δ {T}_{j - 1 r}^{cp} + {S}_{j - 1 r - 1} σ ( {T}_{j - 1 r - 1}^{cp} , {S}_{j - 1 r - 1} ) Δ w ( {T}_{j - 1 r}^{cp} ) , S ( {T}_{0} ) = {S}_{0} ,\end{matrix}$$

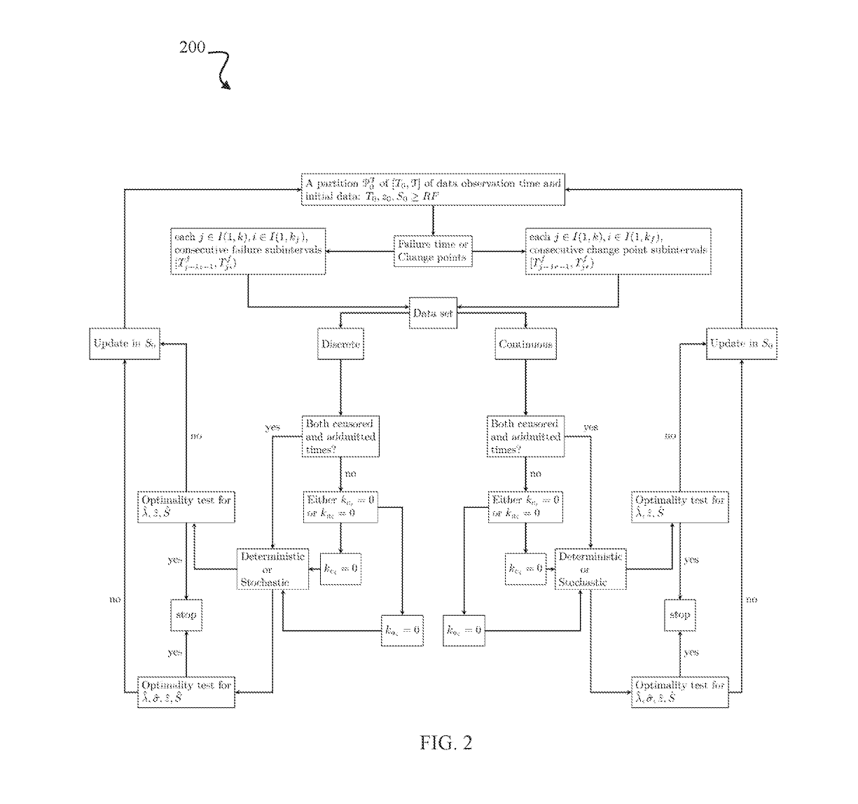

In summary, the overall conceptual computational method for the Interconnected Dynamic Model for Time-to-Event Data Statistic process 120 of present invention is illustrated in the flow diagram 200 of FIG. 2.

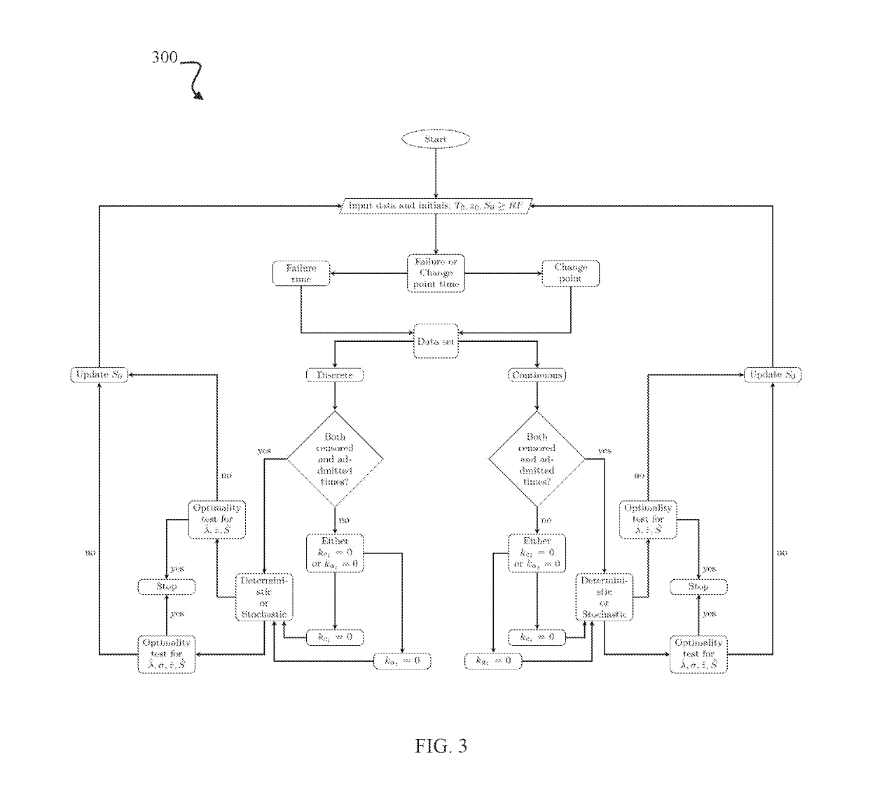

A flow diagram 300 illustrating the simulation computational method for the Interconnected Dynamic Model for Time-to-Event Data Statistic 120 is shown in FIG. 3.

A flow diagram 400 illustrating the conceptual computational method for the Innovative Interconnected Discrete-time Dynamic Model for Nonlinear Time-to-Event Statistical Data Analysis 125 is shown in FIG. 4.

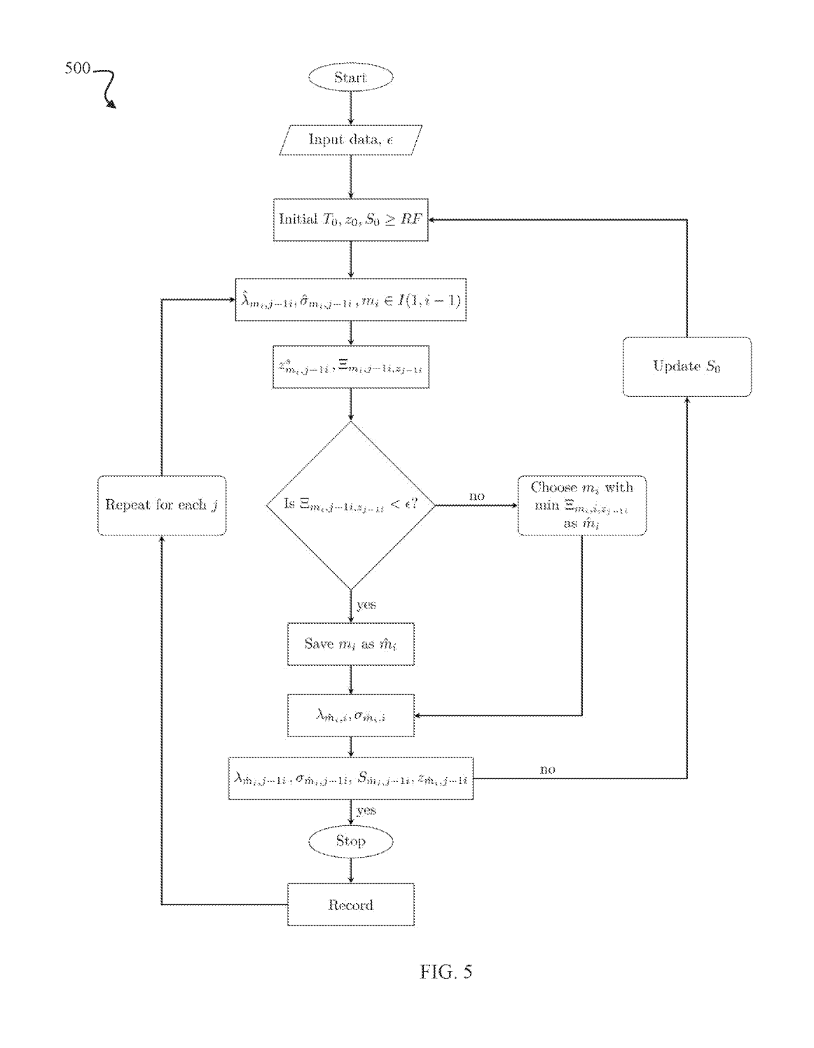

A flow diagram 500 illustrating the simulation computational method for the Innovative Interconnected Discrete-time Dynamic Model for Nonlinear Time-to-Event Statistical Data Analysis 125 is shown in FIG. 5.

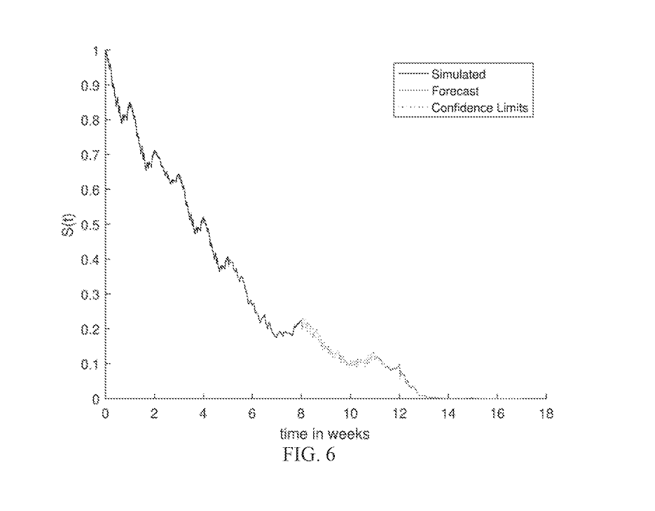

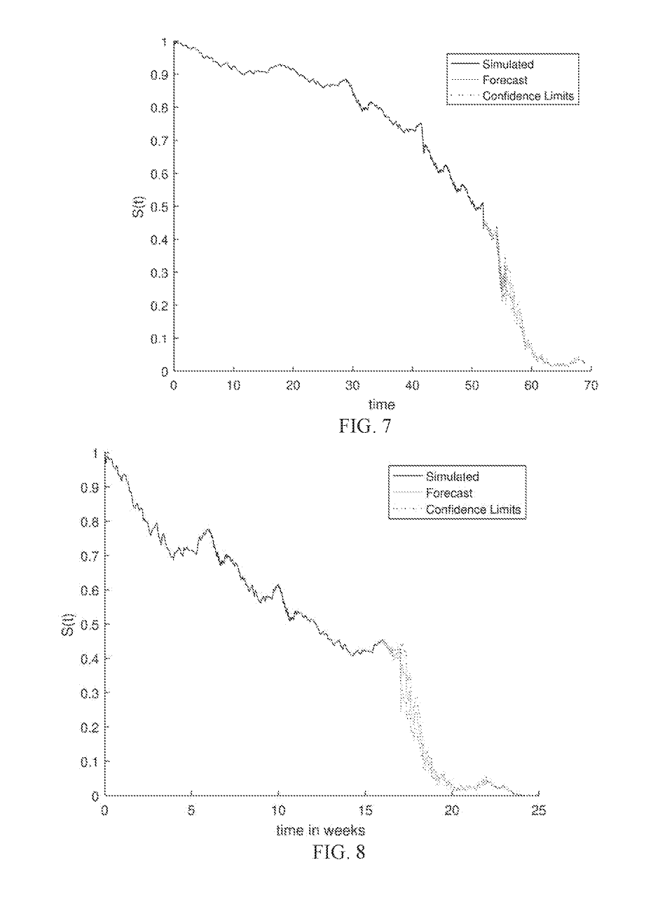

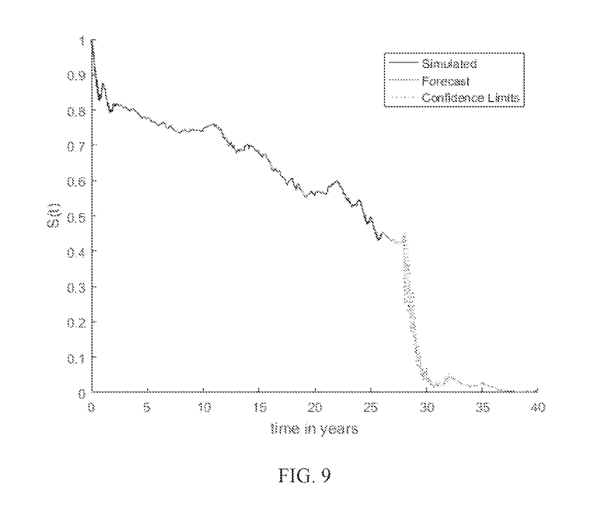

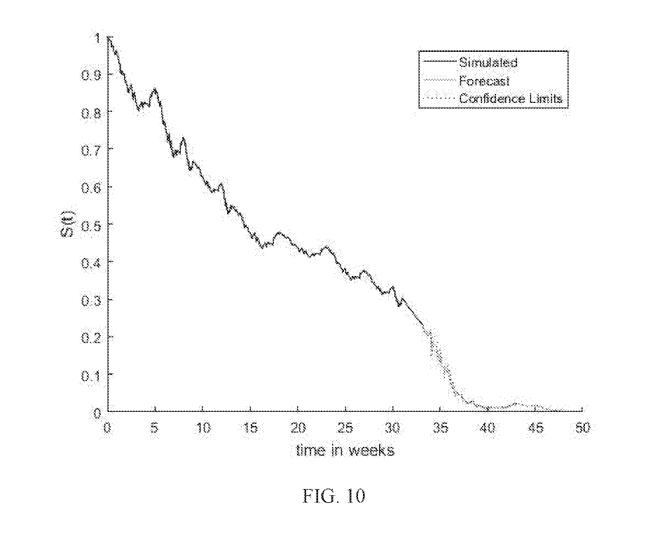

It is further noted that the above described innovative software was employed to study the following five time-to-event data sets. The described procedure systematically applied the Innovative Interconnected Discrete-time Dynamic Model for Nonlinear Time-to-Event Statistical Data Analysis 125 for parameter and survival state estimation problems. Forecast and confidence interval estimates are exhibited for the five data sets include: (1) Length of Remission in Weeks for Control Group of Leukemia Patients, FIG. 6; (2) Numbers of Million Revolutions Failure Times for Each of 23 Bearings, FIG. 7; (3) Length of Remission in Weeks for Treated Group of Leukemia Patients, FIG. 8; (4) The Time-to-Event Data Set in Years of Psychiatric Patients, FIG. 9; and (5) The Remission Time-to-Event in Weeks for Acute Myelogenous Leukaemia (AML) Data Set, FIG. 10.

Additionally, statistical results were developed and compared with the Maximum Likelihood, Kaplan-Meier Methods. As illustrations, the comparative statistical results regarding the following time-to-event data sets: (1) Length of Remission in Weeks for Control Group of Leukemia Patients, (2) Numbers of Million Revolutions Failure Times for Each of 23 Bearings, (3) Length of Remission in Weeks for Treated Group of Leukemia Patients, (4) The Time-to-Event Data Set in Years of Psychiatric Patients, and (5) The Remission Time-to-Event in Weeks for Acute Myelogenous Leukaemia (AML), are reported in the table of FIG. 11, FIG. 12, FIG. 13, FIG. 14, and FIG. 15, respectively.

In addition, further generalizations and extensions of the above outlined innovative algorithm are underway for stochastic linear and nonlinear non-stationary hybrid modeling for time-to-event processes.

The present invention may be embodied on various computing platforms that perform actions responsive to software-based instructions and most particularly on touchscreen portable devices. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. However, as indicated above, due to circuit statutory subject matter restrictions, claims to this invention as a software product are those embodied in a non-transitory software medium such as a computer hard drive, flash-RAM, optical disk or the like.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object oriented programming language such as Java, C#, C++, Visual Basic or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It should be noted that when referenced, an “end-user” is an operator of the software as opposed to a developer or author who modifies the underlying source code of the software. For security purposes, authentication means identifying the particular user while authorization defines what procedures and functions that user is permitted to execute.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

1. A method estimating a time-to-event, the method comprising:
obtaining a time-series data set for a plurality of entities under the influence of one or more intervention processes; and
estimating a time-to-event based upon a combination of a continuous-time analysis and a discrete-time analysis of the historical data and the one or more intervention processes.

2. The method of claim 1, wherein the method of estimating a time-to-event is not dependent upon a probabilistic distribution.

3. The method of claim 1, wherein the intervention processes comprise one or more of, a change in treatment processes, a newly developed technology, a newly developed drugs, newly designed, refined, efficient and effective tools/machines in engineering, usage of modern electronic devices/tools in technological and management sciences, and maximizing diversity, opportunities and benefits for the betterment of the modern civilized global world.

4. The method of claim 1, wherein the one or more intervention processes are selected from intra-interventions, inter-interventions, and extra-interventions.

5. The method of claim 1, wherein estimating a time-to-event based upon a combination of a continuous-time analysis and a discrete-time analysis of the one or more intervention processes further comprises:
identifying a plurality of ordered pairs of change point times and a plurality of ordered pairs of failure point times in the time-series data set; and
dynamically estimating one or more parameters from the ordered pairs of failure point times and the ordered pairs of change point times in the time-series data set.

6. The method of claim 1, wherein estimating a time-to-event based upon a combination of a continuous-time analysis and a discrete-time analysis of the one or more intervention processes further comprises:
identifying a plurality of ordered pairs of change point times and a plurality of ordered pairs of failure point times in the time-series data set; and
dynamically estimating a survival state from the ordered pairs of failure point times and the ordered pairs of change point times in the time-series data set.

7. The method of claim 1, further comprising utilizing a stochastic interconnected nonlinear hybrid dynamic model for survival species and binary state time-to-event process for estimating a time-to-event based upon a combination of a continuous-time analysis and a discrete-time analysis of the historical data and the one or more intervention processes.

8. A system for estimating a time-to-event, the system comprising:
a computer-implemented interconnected hybrid dynamic time-to-event model comprising continuous-time time-to-event processes and discrete-time time-to-event processes;
computer-implemented model configured to:
obtain a time-series data set for a plurality of entities under the influence of one or more intervention processes; and
estimate a time-to-event based upon a combination of a continuous-time analysis and a discrete-time analysis of the historical data and the one or more intervention processes.

9. The system of claim 8, wherein the estimate of the time-to-event is not dependent upon a probabilistic distribution.

10. The system of claim 8, wherein the intervention processes comprise one or more of, a change in treatment processes, a newly developed technology, a newly developed drugs, newly designed, refined, efficient and effective tools/machines in engineering, usage of modern electronic devices/tools in technological and management sciences, and maximizing diversity, opportunities and benefits for the betterment of the modern civilized global world.

11. The system of claim 8, wherein the one or more intervention processes are selected from intra-interventions, inter-interventions, and extra-interventions.

12. The system of claim 8, wherein the computer-implemented model is further configured to:
identify a plurality of ordered pairs of change point times and a plurality of ordered pairs of failure point times in the time-series data set;
dynamically estimate one or more parameters from the ordered pairs of failure point times and the ordered pairs of change point times in the time-series data set; and
dynamically estimate a survival state from the ordered pairs of failure point times and the ordered pairs of change point times in the time-series data set.

13. The system of claim 8, wherein the computer-implemented model is further configured to utilize a stochastic interconnected nonlinear hybrid dynamic model for survival species and binary state time-to-event process for estimating a time-to-event based upon a combination of a continuous-time analysis and a discrete-time analysis of the historical data and the one or more intervention processes.

14. A non-transitory computer-readable medium, the computer-readable medium having computer-readable instructions stored thereon that, when executed by a computing device processor, cause the computing device to:
obtain a time-series data set for a plurality of entities under the influence of one or more intervention processes; and
estimate a time-to-event based upon a combination of a continuous-time analysis and a discrete-time analysis of the historical data and the one or more intervention processes.

15. The non-transitory computer-readable medium of claim 14, wherein estimate of a time-to-event is not dependent upon a probabilistic distribution.

16. The non-transitory computer-readable medium of claim 14, wherein the intervention processes comprise one or more of, a change in treatment processes, a newly developed technology, a newly developed drugs, newly designed, refined, efficient and effective tools/machines in engineering, usage of modern electronic devices/tools in technological and management sciences, and maximizing diversity, opportunities and benefits for the betterment of the modern civilized global world.

17. The non-transitory computer-readable medium of claim 14, wherein the one or more intervention processes are selected from intra-interventions, inter-interventions, and extra-interventions.

18. The non-transitory computer-readable medium of claim 14, further causing the computing device to:
identify a plurality of ordered pairs of change point times and a plurality of ordered pairs of failure point times in the time-series data set; and
dynamically estimate one or more parameters from the ordered pairs of failure point times and the ordered pairs of change point times in the time-series data set.

19. The non-transitory computer-readable medium of claim 14, further causing the computing device to:
identify a plurality of ordered pairs of change point times and a plurality of ordered pairs of failure point times in the time-series data set; and
dynamically estimate a survival state from the ordered pairs of failure point times and the ordered pairs of change point times in the time-series data set.

20. The non-transitory computer-readable medium of claim 14, further causing the computing device to utilize a stochastic interconnected nonlinear hybrid dynamic model for survival species and binary state time-to-event process for estimating a time-to-event based upon a combination of a continuous-time analysis and a discrete-time analysis of the historical data and the one or more intervention processes.
